(19) United States
(12) Patent Application Publication
(10) Pub. No.: US 2008/0292181 A1
(43) Pub. Date: Nov. 27, 2008

(54) Information Processing Method, Information Processing Apparatus, and Storage Medium Storing a Program

(75) Inventors: Tsuneo KASAI, Azumino-shi (JP); Kaori MATSUMOTO, Shiojiri-shi (JP); Hirokazu KASAHARA, Okaya-shi (JP); Kenji FUKASAWA, Matsumoto-shi (JP); Naoki KUWATA, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/061,509

(22) Filed: Apr. 2, 2008

(30) Foreign Application Priority Data
Apr. 4, 2007 (JP) 2007-098702
Dec. 6, 2007 (JP) 2007-316328

(51) Int. Cl. G06K 9/62

(52) U.S. Cl. 382/159

(57) ABSTRACT

An information processing method includes: for image data of each of a plurality of images, obtaining scene information concerning the image data from supplemental data that is appended to the image data, classifying a scene of an image represented by the image data, based on the image data, comparing the classified scene with a scene indicated by the scene information; and if there is a mismatch image for which the classified scene does not match the scene indicated by the scene information, displaying information concerning the mismatch image on a confirmation screen.

### CROSS-REFERENCE TO RELATED APPLICATIONS

The present application claims priority upon Japanese Patent Application No. 2007-098702 filed on Apr. 4, 2007, and Japanese Patent Application No. 2007-316328 filed on Dec. 6, 2007, which are herein incorporated by reference.

### BACKGROUND

1. Technical Field

The present invention relates to information processing methods, information processing apparatuses, and storage media storing a program.

2. Related Art

There are digital still cameras that have mode setting dials for setting the shooting mode. When the user sets a shooting mode using the dial, the digital still camera determines shooting conditions (such as exposure time) according to the shooting mode and takes a picture. When the picture is taken, the digital still camera generates an image file. This image file contains image data concerning the photographed image and supplemental data concerning, for example, the shooting conditions when photographing the image, which is appended to the image data.

On the other hand, it is also common to subject the image data to image processing according to the supplemental data. For example, when a printer performs printing based on the image file, the image data is enhanced according to the shooting conditions indicated by the supplemental data and printing is performed in accordance with the enhanced image data.

JP-A-2001-238177 is an example of related art.

When a digital still camera creates an image file, scene information in accordance with the dial settings may be stored in the supplemental data. On the other hand, when the user forgets to set the shooting mode, scene information that does not match the content of the image data may be stored in the supplemental data. Therefore, the scene of the image data may be classified by analyzing the image data, without using the scene information of the supplemental data.

### SUMMARY

An advantage of some aspects of the present invention is that it is possible to improve the ease of viewing of a confirmation screen with which the user confirms information about an image file in the case where the scene indicated by the supplement data does not match the scene of the classification result.

An aspect of the invention is an information processing method, including:

for image data of each of a plurality of images,
obtaining scene information concerning the image data from supplemental data that is appended to the image data,
classifying a scene of an image represented by the image data, based on the image data,
comparing the classified scene with a scene indicated by the scene information; and

if there is a mismatch image for which the classified scene does not match the scene indicated by the scene information, displaying information concerning the mismatch image on a confirmation screen.

Other features of the present invention will become clear by reading the description of the present specification with reference to the accompanying drawings.

### BRIEF DESCRIPTION OF THE DRAWINGS

For a more complete understanding of the present invention and the advantages thereof, reference is now made to the following description taken in conjunction with the accompanying drawings wherein:

FIG. 1 is an explanatory diagram illustrating an image processing system;

FIG. 2 is an explanatory diagram of the configuration of a printer;

FIG. 3 is an explanatory diagram of a structure of an image file;

FIG. 4A is an explanatory diagram of tags used in IFD0. FIG. 4B is an explanatory diagram of tags used in Exif SubIFD;

FIG. 5 is a correspondence table that shows the correspondence between the settings of a mode setting dial and data;

FIG. 6 is an explanatory diagram of the automatic enhancement function of a printer;

FIG. 7 is an explanatory diagram of the relationship between scenes of images and enhancement details;

FIG. 8 is a flowchart of scene classification processing by a scene classification section;

FIG. 9 is an explanatory diagram of functions of the scene classification section;

FIG. 10 is a flowchart of the overall classification processing;

FIG. 11 is an explanatory diagram of a classification target table;

FIG. 12 is an explanatory diagram of the positive threshold in the overall classification processing;

FIG. 13 is an explanatory diagram of Recall and Precision;

FIG. 14 is an explanatory diagram of a first negative threshold;

FIG. 15 is an explanatory diagram of a second negative threshold;

FIG. 16A is an explanatory diagram of thresholds in a landscape classifying section; FIG. 16B is an explanatory diagram of an outline of processing by the landscape classifying section;

FIG. 17 is a flowchart of the partial classification process;

FIG. 18 is an explanatory diagram of the order in which partial images are selected by a sunset scene partial classifying section;

FIG. 19 shows graphs of Recall and Precision when a sunset scene image is classified using only the top-ten partial images;

FIG. 20A is an explanatory diagram of classification using a linear support vector machine; FIG. 20B is an explanatory diagram of classification using a kernel function;

FIG. 21 is a flowchart of the integrative classification processing;

FIG. 22 is a flowchart showing the process flow of direct printing according to the first embodiment;

FIGS. 23A and 23B are explanatory diagrams of examples of confirmation screens according to the first embodiment;

FIG. 24 is a flowchart showing the process flow of direct printing according to the second embodiment;

FIG. 25 is an explanatory diagram showing an example of the confirmation screen 164 according to the second embodiment;

FIG. 26 is an explanatory diagram of another confirmation screen;

FIG. 27 is an explanatory diagram of a configuration of an APP1 segment when the classification result is added to the supplemental data;

FIG. 28 is an explanatory diagram of a separate process flow; and

FIG. 29A and FIG. 293 are explanatory diagrams of a warning screen.

### DESCRIPTION OF EXEMPLARY EMBODIMENTS

At least the following matters will be made clear by the explanation in the present specification and the description of the accompanying drawings.

An information processing method is provided, comprising:

for image data of each of a plurality of images,
obtaining scene information concerning the image data from supplemental data that is appended to the image data,
classifying a scene of an image represented by the image data, based on the image data,
comparing the classified scene with a scene indicated by the scene information; and

if there is a mismatch image for which the classified scene does not match the scene indicated by the scene information, displaying information concerning the mismatch image on a confirmation screen.

With such an information processing method, the ease of viewing of the confirmation screen is improved.

It is preferable that information concerning the mismatch image is displayed on the confirmation screen, and a matching image for which there is no mismatch between the classified scene and the scene indicated by the scene information is not displayed on the confirmation screen. Thus, the ease of viewing of the confirmation screen is improved.

It is preferable that a matching image for which there is no mismatch between the classified scene and the scene indicated by the scene information is subjected to image processing before the mismatch image is subjected to image processing. Thus, the image processing can be started earlier.

It is preferable that a matching image for which there is no mismatch between the classified scene and the scene indicated by the scene information is subjected to image processing while the confirmation screen is displayed. Thus, the image processing can be started earlier.

It is preferable that a print job for a matching image for which there is no mismatch between the classified scene and the scene indicated by the scene information is created before displaying the confirmation screen; a print job for the mismatch image is created after displaying the confirmation screen; and the print jobs are executed in accordance with a priority order of the print jobs. Thus, the image processing can be started earlier.

It is preferable that the priority order of the print jobs is changed after creating the print job for the mismatch image. Thus, the number of image files that are image-processed in a predetermined order can be increased. Here, the predetermined order may be the order of the numbers associated with the image files, the order of the names of the image files or the order of the times at which the image files were generated (captured).

It is preferable that, after creating the print job for the mismatch image: if the print jobs can be executed in accordance with a predetermined order for the image data of the plurality of images, the priority order of the print jobs is changed to the predetermined order; and if the print jobs cannot be executed in accordance with the predetermined order for the image data of the plurality of images, the priority order of the print jobs is not changed. Thus, it is possible to execute jobs in accordance with the order of the image data of the plurality of images.

It is preferable that, after creating the print job for the mismatch image, if the print jobs cannot be executed in accordance with the predetermined order for the image data of the plurality of images, a warning screen is displayed. Thus, the user can be called to attention.

Furthermore, an information processing apparatus is provided that comprises a controller,

wherein the controller, for image data of a plurality of images,

obtains scene information concerning the image data from supplemental data that is appended to the image data,

classifies a scene of an image represented by the image data, based on the image data,

compares the classified scene with a scene indicated by the scene information, and

if there is a mismatch image for which the classified scene does not match the scene indicated by the scene information, displaying information concerning the mismatch image on a confirmation screen.

With this information processing apparatus, the ease of viewing of the confirmation screen is improved.

Furthermore, a storage medium is provided that stores a program causing an information processing apparatus to, for image data of a plurality of images,

obtain scene information concerning the image data from supplemental data that is appended to the image data,

classify a scene of an image represented by the image data, based on the image data,

compare the classified scene with a scene indicated by the scene information, and

if there is a mismatch image for which the classified scene does not match the scene indicated by the scene information, display information concerning the mismatch image on a confirmation screen.

With this storage medium storing a program, the ease of viewing of the confirmation screen is improved.

### Overall Configuration

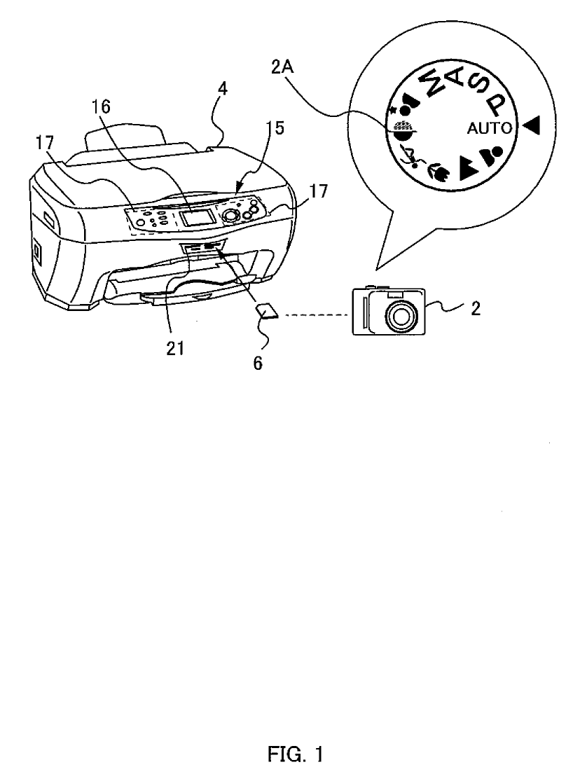

FIG. 1 is an explanatory diagram of an image processing system. This image processing system includes a digital still camera 2 and a printer 4.

The digital still camera 2 captures a digital image by forming an image of a photographic subject onto a digital device (such as a CCD). The digital still camera 2 is provided with a mode setting dial 2A. With this dial 2A, the user can set shooting modes in accordance with the shooting conditions. For example, when the dial 2A is set to the “night scene” mode, the digital still camera 2 makes the shutter speed long or increases the ISO sensitivity to take a picture with shooting conditions suitable for photographing a night scene.

The digital still camera 2 saves the image file generated by the image-taking to a memory card 6 in conformity with the file format standards. The image file contains not only the digital data (image data) of the captured image, but also supplemental data, such as the shooting conditions (shooting data), when the picture was shot.

The printer 4 is a printing apparatus that prints an image represented by the image data on paper. The printer 4 is provided with a memory slot 21 into which the memory card 6 can be inserted. Retrieving the memory card 6 from the digital still camera 2 after image-taking with the digital still camera 2, the user can insert the memory card 6 into the memory slot 21.

A panel section 15 includes a display section 16 and an input section 17 with various buttons. The display section 16 is constituted by a liquid crystal display. If the display section 16 is a touch panel, then the display section 16 functions also as the input section 17. The display section 16 displays, for example, a setting screen for performing settings on the printer 4, images of the image data read in from the memory card, or screens for confirmations or warnings directed at the user. It should be noted that the various screens displayed by the display section 16 are explained further below.

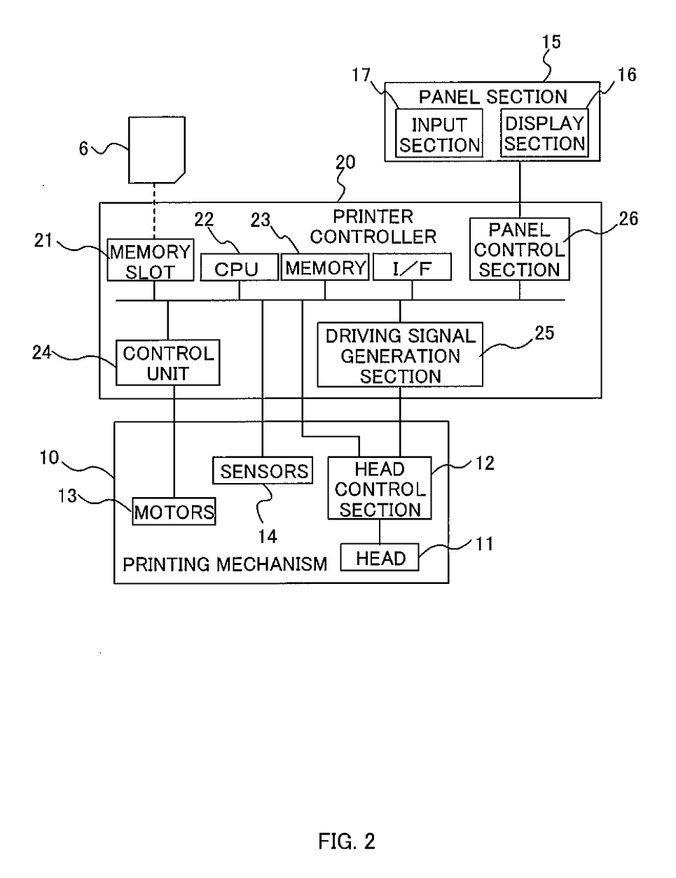

FIG. 2 is an explanatory diagram of a configuration of the printer 4. The printer 4 includes a printing mechanism 10 and a printer controller 20 that controls the printing mechanism 10. The printing mechanism 10 includes a head 11 that ejects ink, a head control section 12 that controls the head 11, motors 13 for, for example, transporting paper, and sensors 14. The printer controller 20 includes the memory slot 21 for sending/receiving data to/from the memory card 6, a CPU 22, a memory 23, a control unit 24 that controls the motors 13, and a driving signal generation section 25 that generates driving signals (driving waveforms). Moreover, the printer controller 20 also includes a panel control section 26 that controls the panel section 15.

When the memory card 6 is inserted into the memory slot 21, the printer controller 20 reads out image files saved on the memory card 6 and stores the image files in the memory 23. Then, the printer controller 20 converts the image data of the image files into print data to be printed by the printing mechanism 10 and controls the printing mechanism 10 based on the print data to print the images on paper. This sequence of operations is called “direct printing.”

It should be noted that “direct printing” is performed not only by inserting the memory card 6 into the memory slot 21, but also can be performed by connecting the digital still camera 2 to the printer 4 via a cable (not shown). The panel section 15 is used for the settings for direct printing (this is explained further below). The panel section 15 is furthermore used to display a confirmation screen and to enter a confirmation when direct printing is performed.

### Structure of Image File

An image file is constituted by image data and supplemental data. The image data is constituted by pixel data of a plurality of pixels. The pixel data is data indicating color information (a tone value) of each pixel. An image is made up of pixels arranged in a matrix form. Accordingly, the image data is data representing an image. The supplemental data includes data indicating the properties of the image data, shooting data, thumbnail image data, and the like.

Hereinafter, a specific structure of an image file is described.

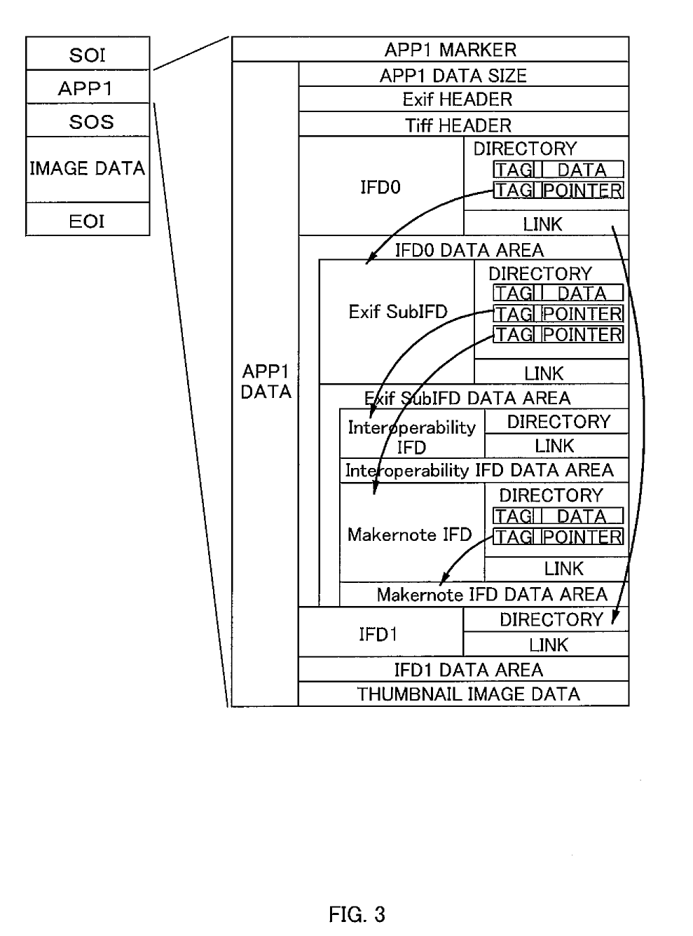

FIG. 3 is an explanatory diagram of a structure of an image file. An overall configuration of the image file is shown on the left side of the figure, and the configuration of an APP1 segment is shown on the right side of the figure.

The image file begins with a marker indicating SOI (Start of image) and ends with a marker indicating EOI (End of image). The marker indicating SOI is followed by an APP1 marker indicating the start of a data area of APP1. The data area of APP1 after the APP1 marker contains supplemental data, such as shooting data and a thumbnail image. Moreover, image data is included after a marker indicating SOS (Start of Stream). After the APP1 marker, information indicating the size of the data area of APP1 is placed, which is followed by an EXIF header, a TIFF header, and then IFD areas.

Every IFD area has a plurality of directory entries, a link indicating the location of the next IFD area, and a data area. For example, the first IFD, which is IFD0 (IFD of main image), links to the location of the next IFD, IFD1 (IFD of thumbnail image). However, there is no further IFD following the IFD1 here, so that the IFD1 does not link to any other IFDs. Every directory entry contains a tag and a data section. When a small amount of data is to be stored, the data section stores actual data as it is, whereas when a large amount of data is to be stored, actual data is stored in an IFD0 data area and the data section stores a pointer indicating the storage location of the data. It should be noted that the IFD0 contains a directory entry in which a tag (Exit IFD Pointer), meaning the storage location of an Exif SubIFD, and a pointer (offset value), indicating the storage location of the Exif SubIFD, are stored.

The Exif SubIFD area has a plurality of directory entries. These directory entries also contain tags and data sections. When a small amount of data is to be stored, the data sections store actual data as it is, whereas when a large amount of data is to be stored, the actual data is stored in an Exif SubIFD data area and the data sections store pointers indicating the storage location of the data. It should be noted that the Exif SubIFD stores a tag meaning the storage location of a Makernote IFD and a pointer indicating the storage location of the Makernote IFD.

The Makernote IFD area has a plurality of directory entries. These directory entries also contain tags and data sections. When a small amount of data is to be stored, the data sections store actual data as it is, whereas when a large amount of data is to be stored, the actual data is stored in a Makernote IFD data area and the data sections store pointers indicating the storage location of the data. However, regarding the Makernote IFD area, the data storage format can be defined freely, so that data is not necessarily stored in this format. In the following description, data stored in the Makernote IFD area is referred to as “MakerNote data.”

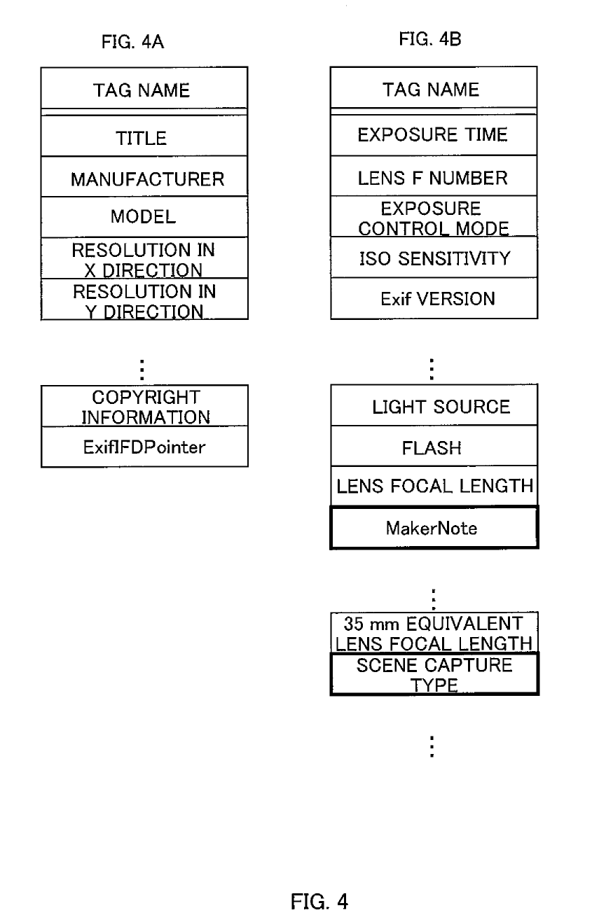

FIG. 4A is an explanatory diagram of tags used in IFD0. As shown in the diagram, the IFD0 stores general data (data indicating the properties of the image data) and no detailed shooting data.

FIG. 4B is an explanatory diagram of tags used in Exif SubIFD. As shown in the diagram, the Exif SubIFD stores detailed shooting data. It should be noted that most of shooting data that is extracted during scene classification processing is shooting data stored in the Exif SubIFD. The scene capture type tag (Scene Capture Type) is a tag indicating the type of a photographed scene. Moreover, the Makernote tag is a tag meaning the storage location of the Makernote IFD. When a data section (scene capture type data) corresponding to the scene capture type tag in the Exif SubIFD is “zero,” it means “Normal,” “1” means “landscape,” “2” means “portrait,” and “3” means “night-scene.” It should be noted that since data stored in the Exif SubIFD is standardized, anyone can understand the contents of this scene capture type data.

In the present embodiment, the MakerNote data includes shooting mode data. This shooting mode data represents different values corresponding to different modes set with the mode setting dial 2A. However, since the format of the MakerNote data varies from manufacturer to manufacturer, it is impossible to determine the details of the shooting mode data unless the format of the MakerNote data is known.

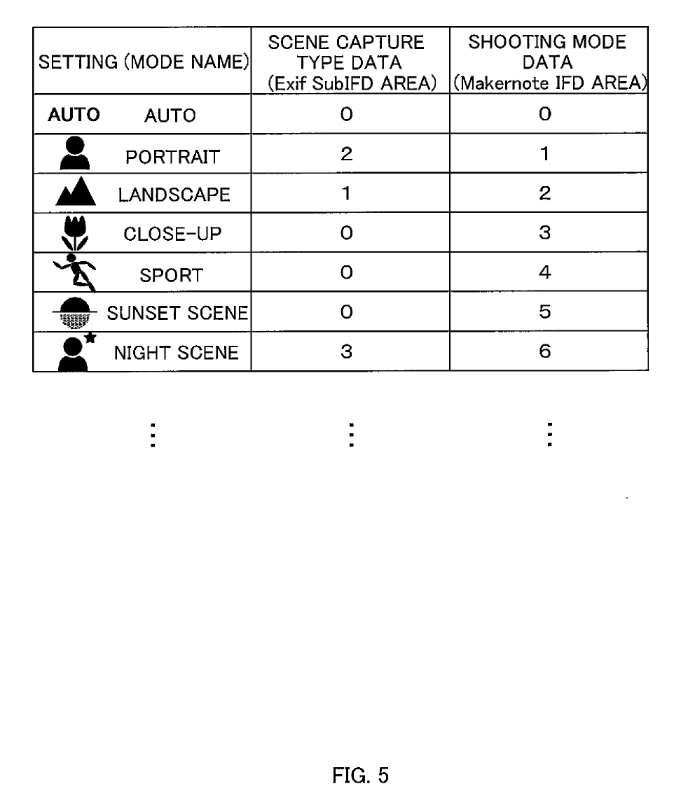

FIG. 5 is a correspondence table that shows the correspondence between the settings of the mode setting dial 2A and the data. The scene capture type tag used in the Exif SubIFD is in conformity with the file format standard, so that scenes that can be specified are limited, and thus data specifying scenes such as “sunset scene” cannot be stored in a data section. On the other hand, the MakerNote data can be defined freely, so that data specifying the shooting mode of the mode setting dial 2A can be stored in a data section using a shooting mode tag, which is included in the MakerNote data.

After taking a picture with shooting conditions according to the setting of the mode setting dial 2A, the above-described digital still camera 2 creates an image file such as described above and saves the image file on the memory card 6. This image file contains the scene capture type data and the shooting mode data according to the mode setting dial 2A, which are stored in the Exit SubIFD area and the Makernote IFD area, respectively, as scene information appended to the image data.

### Outline of Automatic Enhancement Function

When “portrait” pictures are printed, it is often desirable to improve the skin tones. Moreover, when “landscape” pictures are printed, it is often desirable that the blue color of the sky be emphasized and the green color of trees and plants be emphasized. Thus, the printer 4 of the present embodiment has an automatic enhancement function of analyzing the image file and automatically performing appropriate enhancement processing.

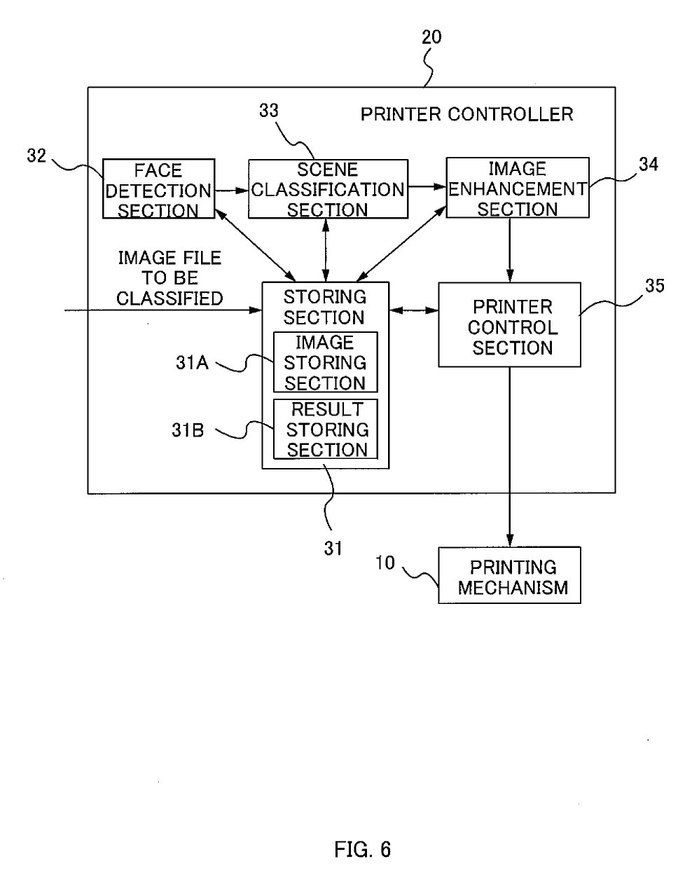

FIG. 6 is an explanatory diagram of the automatic enhancement function of the printer 4. The components of the printer controller 20 in the diagram are realized with software and hardware.

A storing section 31 is realized with a certain area of the memory 23 and the CPU 22. All or a part of the image file that has been read out from the memory card 6 is decoded in an image storing section 31A of the storing section 31. The results of the calculations performed by the components of the printer controller 20 are stored in a result storing section 31B of the storing section 31.

A face detection section 32 is realized with the CPU 22 and a face detection program stored in the memory 23. The face detection section 32 analyzes the image data stored in the image storing section 31A and detects whether or not there is a human face. If the face detection section 32 detects that there is a human face, the image to be classified is classified as belonging to “portrait” scenes. Since the face detection processing performed by the face detection section 32 is similar to processing that is already widespread, a detailed description thereof is omitted.

The face detection section 32 also calculates the probability (degree of certainty, evaluation value) that the image to be classified belongs to “portrait” scenes. This degree of certainty is calculated for example from the proportion of skin-colored pixels making up the image, the shape of the skin-colored image, the colors represented by the pixel data and the degree of closeness of the skin colors to memory colors. The classification result of the face detection section 32 is stored in the result storing section 31B.

The scene classification section 33 is realized with the CPU 22 and a scene classification program stored in the memory 23. The scene classification section 33 analyzes the image file stored in the image storing section 31A and classifies the scene of the image represented by the image data. After the face detection processing with the face detection section 32, the scene classification section 33 performs scene classification processing. As described later, the scene classification section 33 determines which of “landscape,” “sunset scene,” “night scene,” “flower,” and “autumnal,” the image to be classified is classified as. Also the classification result of the scene classification section 33 and the information about the degree of certainty is stored in the result storage section 31B.

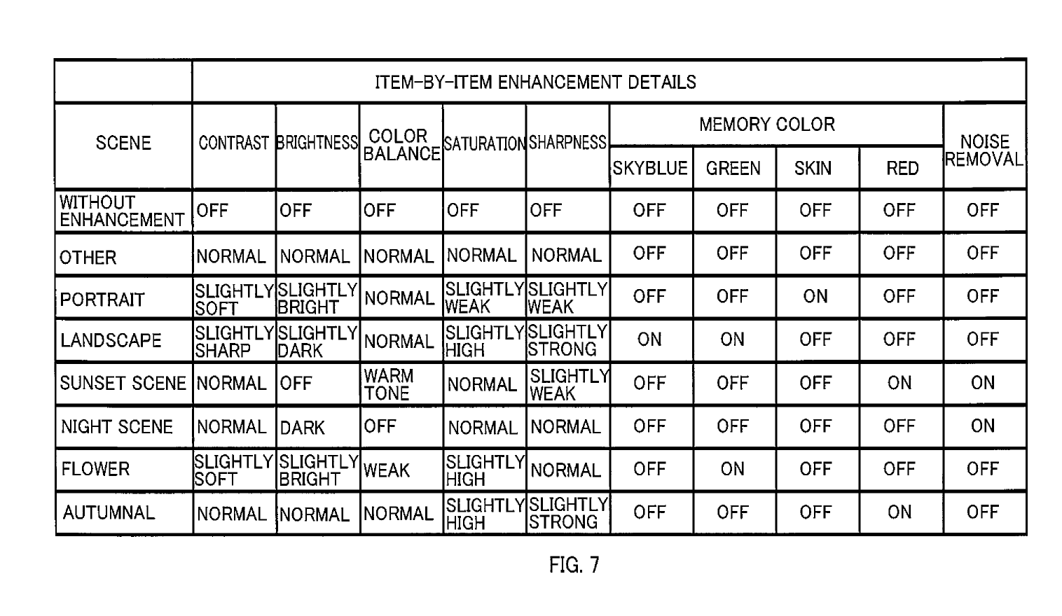

FIG. 7 is an explanatory diagram of the relationship between scenes of images and enhancement details.

An image enhancement section 34 is realized with the CPU 22 and an image enhancement program stored in the memory 23. The image enhancement section 34 enhances the image data in the image storing section 31A based on the classification result (result of classification performed by the face classification section 32 or the scene classification section 33) that has been stored in the result storing section 31B of the storing section 31 (which is explained further below). For example, when the classification result of the scene classification section 33 is “landscape,” the image data is enhanced so that blue and green colors are emphasized. However, if the scene indicated by the supplemental data of the image file does not match the scene represented by the classification result, then the image enhancement section 34 enhances the image data in accordance with the confirmation result, after performing a predetermined confirmation process, which is explained later.

The printer control section 35 is realized with the CPU 22, the driving signal generation section 25, the control unit 24, and a printer control program stored in the memory 23. The printer control section 35 converts the enhanced image data into print data and lets the printing mechanism 10 print the image.

### Scene Classification Processing

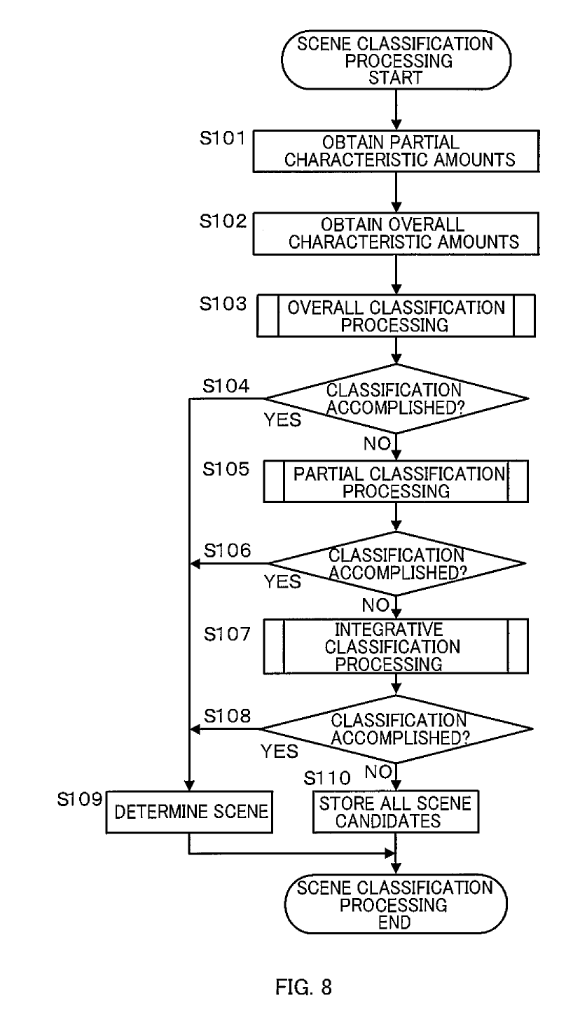

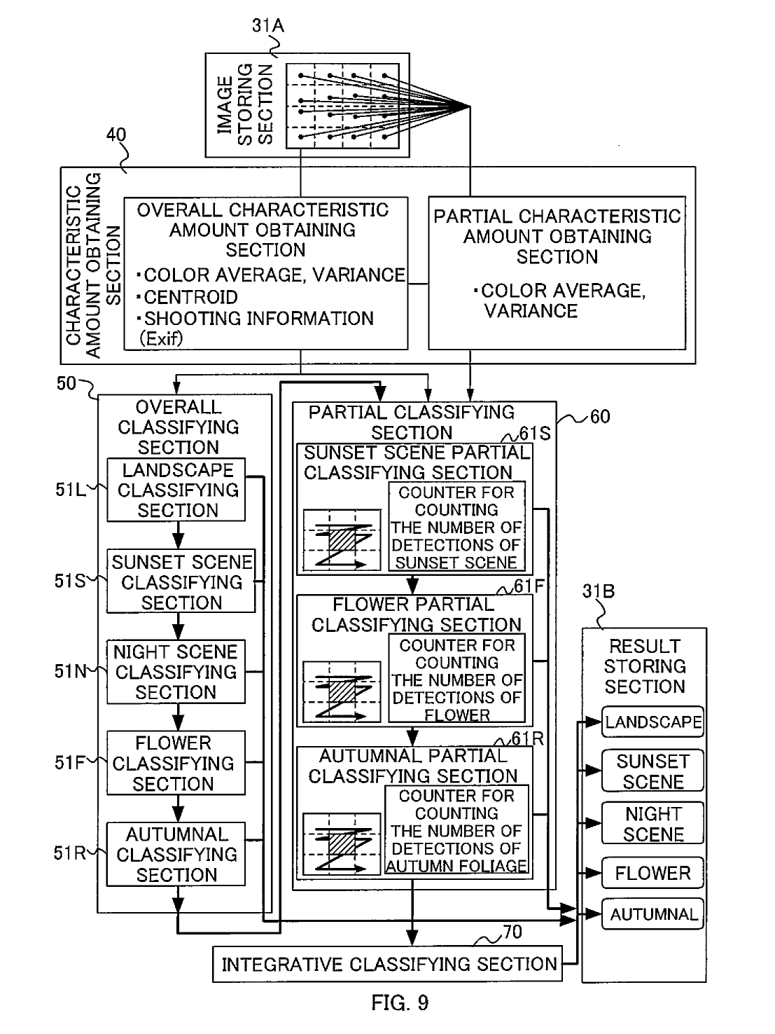

FIG. 8 is a flowchart of the scene classification processing performed by the scene classification section 33. FIG. 9 is an explanatory diagram of functions of the scene classification section 33. The components of the scene classification section 33 shown in the figure are realized with software and hardware. The scene classification section 33 includes a characteristic amount obtaining section 40, an overall classifying section 50, a partial classifying section 60, and an integrative classifying section 70, as shown in FIG. 9.

First, a characteristic amount obtaining section 40 analyzes the image data decoded in the image storing section 31A of the storing section 31 and obtains partial characteristic amounts (S101). More specifically, the characteristic amount obtaining section 40 divides the image data into 8×8=64 blocks, calculates color average and variance of the each of the blocks, and obtains the calculated color averages and variances as partial characteristic amounts. It should be noted that every pixel here includes data about a tone value in the YCC color space, and an average value of Y, an average value of Cb, and an average value of Cr are calculated for each block, and also a variance of X, a variance of Cb, and a variance of Cr are calculated for each block. That is to say, three color averages and three variances are calculated as partial characteristic amounts for each block. These color averages and variances indicate characteristics of the partial image in each block. It should be noted that it is also possible to calculate average values and variances in RGB color space.

Since the color averages and variances are calculated for each block, the characteristic amount obtaining section 40 decodes portions of the image data corresponding to the respective blocks in a block-by-block order without decoding all of the image data in the image storing section 31A. For this reason, the image storing section 31A does not have to be provided with a capacity as is needed for decoding the entire image file.

Next, the characteristic amount obtaining section 40 obtains overall characteristic amounts (S102). Specifically, the characteristic amount obtaining section 40 obtains color averages and variances, a centroid, and shooting information of the entire image data as overall characteristic amounts. It should be noted that these color averages and variances indicate characteristics of the entire image. The color averages and variances and the centroid of the entire image data are calculated using the partial characteristic amounts obtained before. For this reason, it is not necessary to decode the image data again when calculating the overall characteristic amounts, and thus the speed at which the overall characteristic amounts are calculated is increased. It is because the calculation speed is increased in this manner that the overall characteristic amounts are obtained after the partial characteristic amounts, although overall classification processing (described later) is performed before partial classification processing (described later). It should be noted that the shooting information is extracted from the shooting data in the image file. More specifically, information such as the aperture value, the shutter speed, and whether or not the flash is fired, is used as the overall characteristic amounts. However, not all of the shooting data in the image file is used as the overall characteristic amounts.

Next, an overall classifying section 50 performs the overall classification processing (S103). The overall classification processing is processing for classifying (estimating) the scene of the image represented by the image data based on the overall characteristic amounts. A detailed description of the overall classification processing is provided later.

If the scene can be classified by the overall classification processing (“YES” in S104), the scene classification section 33 determines the scene by storing the classification result in the result storing section 31B of the storing section 31 (S109) and terminates the scene classification processing. That is to say, if the scene can be classified by the overall classification processing (“YES” in S104), the partial classification processing and integrative classification processing are omitted. Thus, the speed of the scene classification processing is increased.

If the scene cannot be classified by the overall classification processing (“NO” in S104), a partial classifying section 60 then performs the partial classification processing (S105). The partial classification processing is processing for classifying the scene of the entire image represented by the image data based on the partial characteristic amounts. A detailed description of the partial classification processing is provided later.

If the scene can be classified by the partial classification processing (“YES” in S106), the scene classification section 33 determines the scene by storing the classification result in the result storing section 31B of the storing section 31 (S109) and terminates the scene classification processing. That is to say, if the scene can be classified by the partial classification processing (“YES” in S106), the integrative classification processing is omitted. Thus, the speed of the scene classification processing is increased.

If the scene cannot be classified by the partial classification processing (“NO” in S106), an integrative classifying section 70 performs the integrative classification processing (S107). A detailed description of the integrative classification processing is provided later.

If the scene can be classified by the integrative classification processing (“YES” in S108), the scene classification section 33 determines the scene by storing the classification result in the result storing section 31B of the storing section 31 (S109) and terminates the scene classification processing. On the other hand, if the scene cannot be classified by the integrative classification processing (“NO” in S108), the scene classification section 33 stores all scenes serving as candidates (scene candidates) in the result storing section 313 (S110). At this time, also the degree of certainty is stored in the result storing section 31B together with the scene candidates.

If the result of the scene classification processing (overall classification processing, partial classification processing, integrative classification processing) is “YES” in any of the steps S104, S106, and S108 in FIG. 8, then the printer controller 20 can classify one scene with a relatively high degree of certainty. If the result is “NO” in step S108, then the printer controller 20 can classify at least one scene (scene candidate) with a relatively low degree of certainty. It should be noted that if the result is “NO” in step S108, then there may be one scene candidate or there may be two or more scene candidates.

### Overall Classification Processing

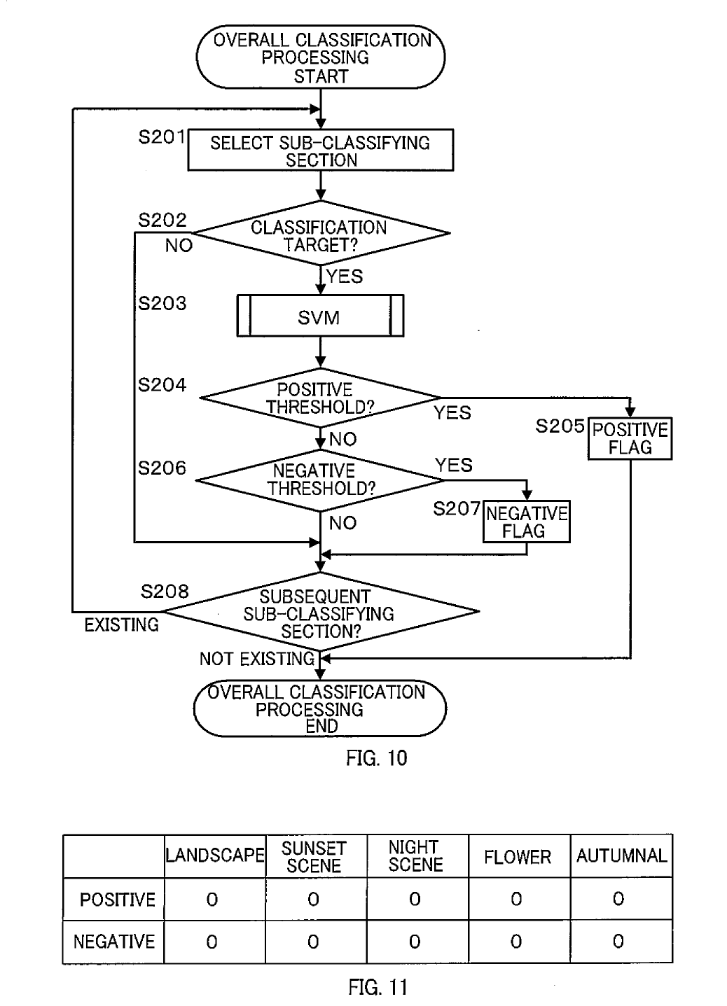

FIG. 10 is a flowchart of overall classification processing. Here, the overall classification processing is described also with reference to FIG. 9.

First, the overall classifying section 50 selects one sub-classifying section 51 from a plurality of sub-classifying sections 51 (S201). The overall classifying section 50 is provided with five sub-classifying sections 51 that classify whether or not the image serving as an object of classification (image to be classified) belongs to a specific scene. The five sub-classifying sections 51 classify landscape scenes, sunset scenes, night scenes, flower scenes, and autumnal scenes, respectively. Here, the overall classifying section 50 selects the sub-classifying sections 51 in the order of landscape→sunset→night→flower→autumnal scene. For this reason, at the start, the sub-classifying section 51 (landscape classifying section 51L) for classifying whether or not the image to be classified belongs to landscape scenes is selected.

Next, the overall classifying section 50 references an classification target table and determines whether or not to classify the scene using the selected sub-classifying section 51 (S202).

FIG. 11 is an explanatory diagram of a classification target table. This classification target table is stored in the result storing section 31B of the storing section 31. At the first stage, all the fields in the classification target table are set to zero. In the process of S202, a “negative” field is referenced, and when this field is zero, the result is judged to be “YES,” and when this field is 1, the result is judged to be “NO.” Here, the overall classifying section 50 references the “negative” field in the “landscape” column of the classification target table to find that this field is zero and thus the judgment result is “YES.”

Next, the sub-classifying section 51 calculates the value of a discriminant equation (evaluation value) based on the overall characteristic amounts (S203). The value of this discriminant equation relates to the probability (degree of certainty) that the image to be classified belongs to a specific scene (this is explained further below). The sub-classifying sections 51 of the present embodiment employ a classification method using a support vector machine (SVM). A description of the support vector machine is provided later. If the image to be classified belongs to a specific scene, the discriminant equation of the sub-classifying section 51 is likely to have a positive value. When the image to be classified does not belong to a specific scene, the discriminant equation of the sub-classifying section 51 is likely to have a negative value. Moreover, the higher the degree of certainty that the image to be classified belongs to a specific scene is, the larger the value of the discriminant equation is. Accordingly, a large value of the discriminant equation indicates a high probability (degree of certainty) that the image to be classified belongs to a specific scene, and a small value of the discriminant equation indicates a low probability that the image to be classified belongs to a specific scene.

Therefore, the value (evaluation value) of the discriminant equation indicates the degree of certainty, i.e., the degree to which it is certain that the image to be classified belongs to a specific scene. It should be noted that the term “degree of certainty” as used in the following description may refer to the value itself of the discriminant equation or to a ratio of correct answers (described later) that can be obtained from the value of the discriminant equation. The value of the discriminant equation itself or the ratio of correct answers (described later) that can be obtained from the value of the discriminant equation is also an “evaluation value” (evaluation result) depending on the probability that the image to be classified belongs to a specific scene. In the course of the face detection described above, the face detection section 32 calculates the probability (evaluation value) that the image to be classified belongs to “portrait” scenes, and this evaluation value indicates the degree of certainty that the image to be classified belongs to a specific scene.

Next, the sub-classifying section 51 determines whether or not the value of the discriminant equation is larger than a positive threshold (S204). If the value of the discriminant equation is larger than the positive threshold, the sub-classifying section 51 judges that the image to be classified belongs to a specific scene.

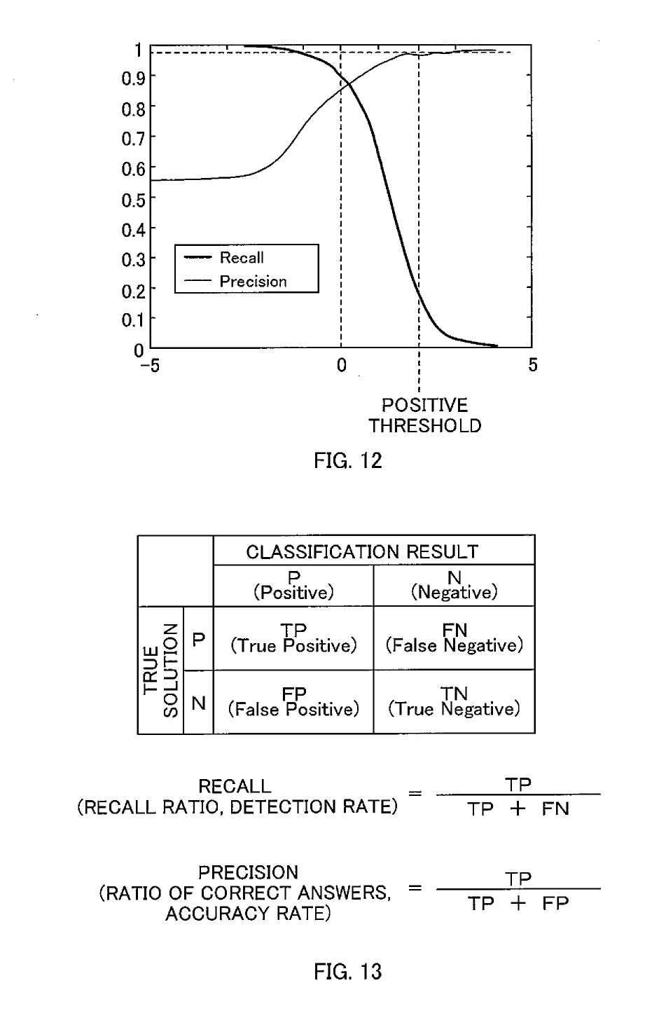

FIG. 12 is an explanatory diagram of the positive threshold in the overall classification processing. In this diagram, the horizontal axis represents the positive threshold, and the vertical axis represents the probabilities of Recall and Precision. FIG. 13 is an explanatory diagram of Recall and Precision. If the value of the discriminant equation is equal to or more than the positive threshold, the classification result is taken to be positive, and if the value of the discriminant equation is not equal to or more than the positive threshold, the classification result is taken to be negative.

Recall indicates the recall ratio or detection rate. Recall is the proportion of the number of images classified as belonging to a specific scene to the total number of images of that specific scene. In other words, Recall indicates the probability that, when the sub-classifying section 51 is used to classify an image of a specific scene, the sub-classifying section 51 makes a positive classification (the probability that the image of the specific scene is classified as belonging to that specific scene). For example, Recall indicates the probability that, when the landscape classifying section 51L is used to classify a landscape image, the landscape classifying section 51L classifies the image as belonging to landscape scenes.

Precision indicates the ratio of correct answers or accuracy rate. Precision is the proportion of the number of images of a specific scene to the total number of positively classified images. In other words, Precision indicates the probability that, when the sub-classifying section 51 for classifying a specific scene positively classifies an image, the image to be classified is the specific scene. For example, Precision indicates the probability that, when the landscape classifying section 51L classifies an image as belonging to landscape scenes, the classified image is actually a landscape image.

As can be seen from FIG. 12, the larger the positive threshold is, the greater Precision is. Thus, the larger the positive threshold is, the higher the probability that an image classified as belonging to, for example, landscape scenes is a landscape image is. That is to say, the larger the positive threshold is, the lower the probability of misclassification is.

On the other hand, the larger the positive threshold is, the smaller the Recall is. As a result, for example, even when a landscape image is classified by the landscape classifying section 51L, it is difficult to correctly classify the image as belonging to landscape scenes. When the image to be classified can be classified as belonging to landscape scenes (“YES” in S204), classification with respect to the other scenes (such as sunset scenes) is no longer performed, and thus the speed of the overall classification processing is increased. Therefore, the larger the positive threshold is, the lower the speed of the overall classification processing is. Moreover, since the speed of the scene classification processing is increased by omitting the partial classification processing when scene classification can be accomplished by the overall classification processing (S104), the larger the positive threshold is, the lower the speed of the scene classification processing is.

That is to say, too small a positive threshold will result in a high probability of misclassification, and too large a positive threshold will result in a decreased processing speed. In the present embodiment, the positive threshold for landscapes is set to 1.72 in order to set the ratio of correct answers (Precision) to 97.5%.

If the value of the discriminant equation is larger than the positive threshold (“YES” in S204), then the subclassifying section 51 determines that the image to be classified belongs to a specific scene, and sets a positive flag (S205). “Set a positive flag” refers to setting a “positive” field in FIG. 11 to 1. In this case, the overall classifying section 50 terminates the overall classification processing without performing classification by the subsequent sub-classifying sections 51. For example, if an image can be classified as a landscape image, the overall classifying section 50 terminates the overall classification processing without performing classification with respect to sunset scenes and so on. In this case, the speed of the overall classification processing can be increased because classification by the subsequent sub-classifying sections 51 is omitted.

If the value of the discriminant equation is not larger than the positive threshold (“NO” in S204), then the sub-classifying section 51 cannot judge the image to be classified as belonging to a specific scene, and performs the subsequent process of S206.

Then, the sub-classifying section 51 compares the value of the discriminant equation with a negative threshold (S206). Based on this comparison, the sub-classifying section 51 may determine that the image to be classified does not belong to a predetermined scene. Such a determination is made in two ways. First, if the value of the discriminant equation of the sub-classifying section 51 with respect to a certain specific scene is smaller than a first negative threshold, it is judged that the image to be classified does not belong to that specific scene. For example, if the value of the discriminant equation of the landscape classifying section 51L is smaller than the first negative threshold, it is judged that the image to be classified does not belong to landscape scenes. Second, if the value of the discriminant equation of the sub-classifying section 51 with respect to a certain specific scene is larger than a second negative threshold, then it is judged that the image to be determined does not belong to a scene different from that specific scene. For example, if the value of the discriminant equation of the landscape classifying section 51L is larger than the second negative threshold, then it is determined that the image to be classified does not belong to night scenes.

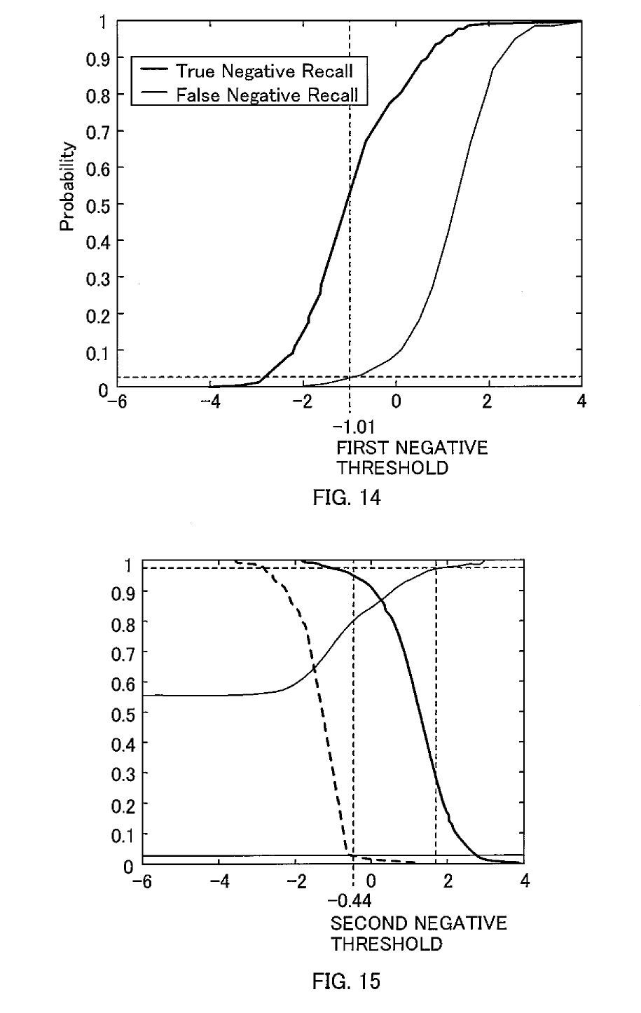

FIG. 14 is an explanatory diagram of a first negative threshold. In this diagram, the horizontal axis represents the first negative threshold, and the vertical axis represents the probability. The bold curve in the graph represents True Negative Recall and indicates the probability that an image that is not a landscape image is correctly classified as not being a landscape image. The thin curve in the graph represents False Negative Recall and indicates the probability that a landscape image is misclassified as not being a landscape image. As can be seen from FIG. 14, the smaller the first negative threshold is, the smaller False Negative Recall is. Thus, the smaller the first negative threshold is, the lower the probability that an image classified as not belonging to, for example, landscape scenes is actually a landscape image becomes. In other words, the probability of misclassification decreases.

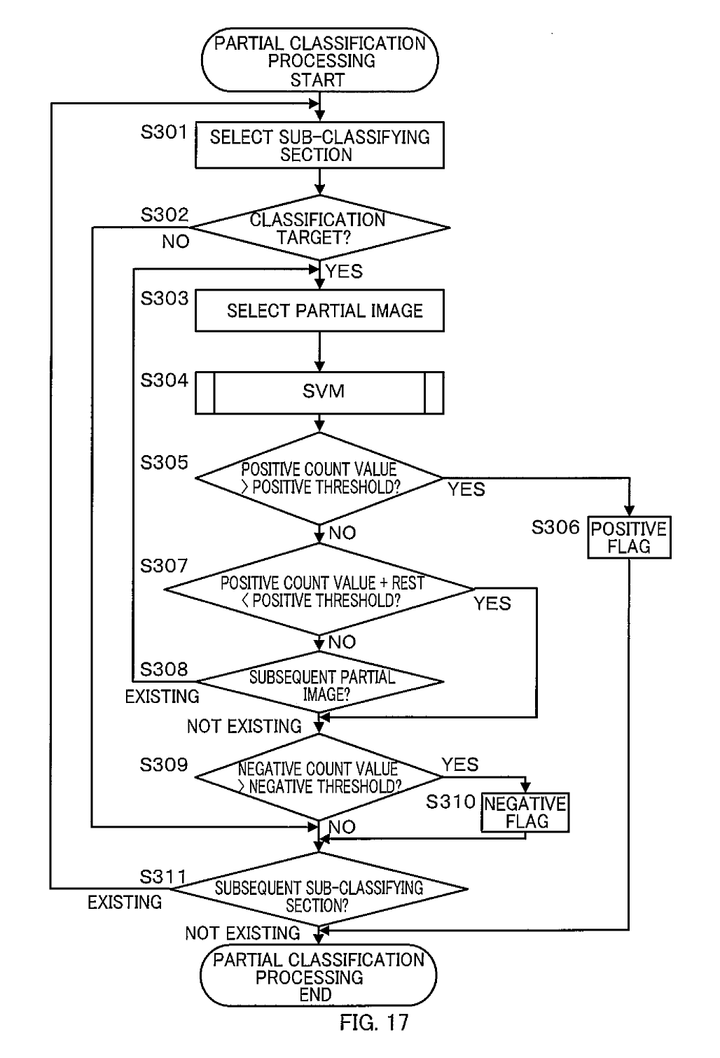

On the other hand, the smaller the first negative threshold is, the smaller True Negative Recall is as well. As a result, an image that is not a landscape image is less likely to be classified as a landscape image. On the other hand, if the image to be classified can be classified as not being a specific scene, processing by a sub-partial classifying section 61 with respect to that specific scene is omitted during the partial classification processing, thereby increasing the speed of the scene classification processing (described later, S302 in FIG. 17). Therefore, the smaller the first negative threshold is, the lower the speed of the scene classification processing is.

That is to say, too large a first negative threshold will result in a high probability of misclassification, and too small a first negative threshold will result in a decreased processing speed. In the present embodiment, the first negative threshold is set to −1.01 in order to set False Negative Recall to 2.5%.

When the probability that a certain image belongs to landscape scenes is high, the probability that this image belongs to night scenes is inevitably low. Thus, when the value of the discriminant equation of the landscape classifying section 51L is large, it may be possible to classify the image as not being a night scene. The second negative threshold is provided in order to perform such classification.

FIG. 15 is an explanatory diagram of a second negative threshold. In this diagram, the horizontal axis represents the value of the discriminant equation with respect to landscapes, and the vertical axis represents the probability. This diagram shows, in addition to the graphs of Recall and Precision shown in FIG. 12, a graph of Recall with respect to night scenes, which is drawn by a dotted line. When looking at this graph drawn by the dotted line, it is found that when the value of the discriminant equation with respect to landscapes is larger than −0.44, the probability that the image to be classified is a night scene image is 2.5%. In other words, even if the image to be classified is classified as not being a night scene image when the value of the discriminant equation with respect to landscapes is larger than −0.44, the probability of misclassification is no more than 2.5%. In the present embodiment, the second negative threshold is therefore set to −0.44.

If the value of the discriminant equation is smaller than the first negative threshold or if the value of the discriminant equation is larger than the second negative threshold (“YES” in S206), the sub-classifying section 51 judges that the image to be classified does not belong to a predetermined scene, and sets a negative flag (S207). “Set a negative flag” refers to setting a “negative” field in FIG. 11 to 1. For example, if it is judged that the image to be classified does not belong to landscape scenes based on the first negative threshold, the “negative” field in the “landscape” column is set to 1. Moreover, if it is judged that the image to be classified does not belong to night scenes based on the second negative threshold, the “negative” field in the “night scene” column is set to 1.

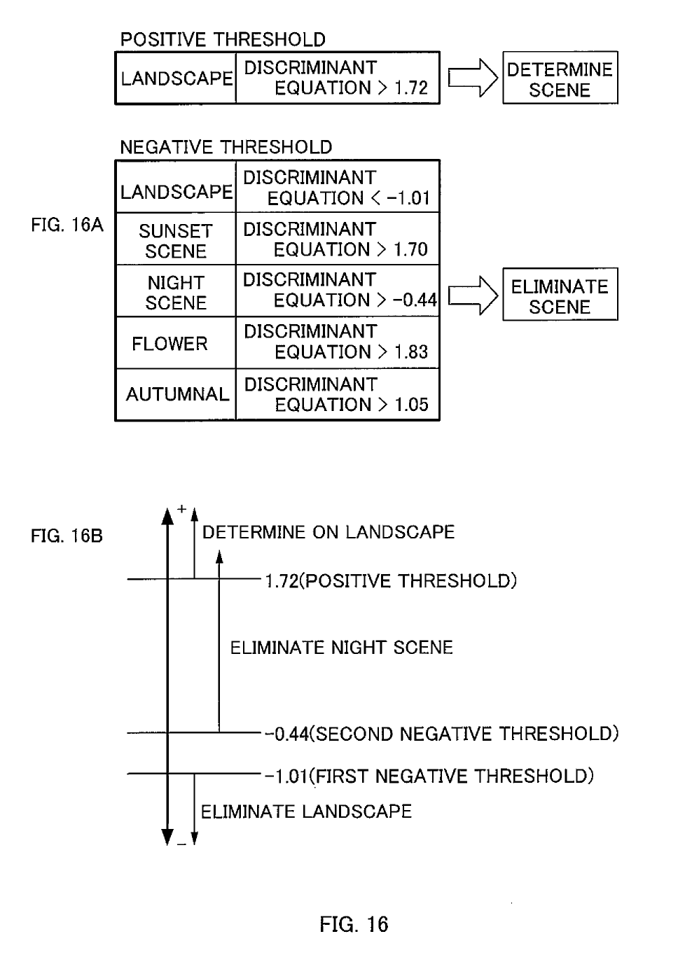

FIG. 16A is an explanatory diagram of the thresholds in the landscape classifying section 51L described above. In the landscape classifying section 51L, a positive threshold and negative thresholds are set in advance. The positive threshold is set to 1.72. The negative thresholds include a first negative threshold and second negative thresholds. The first negative threshold is set to −1.01. The second negative thresholds are set for scenes other than landscapes to respective values.

FIG. 16B is an explanatory diagram of an outline of the processing by the landscape classifying section 51L described above. Here, for the sake of simplicity of description, the second negative thresholds are described with respect to night scenes alone. If the value of the discriminant equation is larger than 1.72 (“YES” in S204), the landscape classifying section 51L judges that the image to be classified belongs to landscape scenes. If the value of the discriminant equation is not larger than 1.72 (“NO” in S204) but larger than −0.44 (“YES” in S206), the landscape classifying section 51L judges that the image to be classified does not belong to night scenes. If the value of the discriminant equation is smaller than −1.01 (“YES” in S206), the landscape classifying section 51L judges that the image to be classified does not belong to landscape scenes. It should be noted that the landscape classifying section 51L also judges with respect to sunset scenes and autumnal scenes whether the image to be classified does not belong to these scenes based on the second negative thresholds. However, since the second negative threshold with respect to flower scenes is larger than the positive threshold, the landscape classifying section 51L will never judge that the image to be classified does not belong to flower scenes.

If “NO” is established in S202, and “NO” is established in S206, or if the process of S207 is finished, the overall classifying section 50 determines whether or not there is a subsequent sub-classifying section 51 (S208). Here, the processing by the landscape classifying section 51L has been finished, so that the overall classifying section 50 determines in S208 that there is a subsequent sub-classifying section 51 (sunset scene classifying section 51S).

Then, if the process of S205 is finished (if it is judged that the image to be classified belongs to a specific scene) or if it is judged in S208 that there is no subsequent sub-classifying section 51 (if it cannot be judged that the image to be classified belongs to a specific scene), the overall classifying section 50 terminates the overall classification processing.

As already described above, when the overall classification processing is terminated, the scene classification section 33 determines whether or not scene classification can be accomplished by the overall classification processing (S104 in FIG. 8). At this time, the scene classification section 33 references the classification target table shown in FIG. 11 and determines whether or not there is a “1” among the “positive” fields.

If scene classification could be accomplished by the overall classification processing (“YES” in S104), the partial classification processing and the integrative classification processing are omitted. Thus, the speed of the scene classification processing is increased.

### Partial Classification Processing

FIG. 17 is a flowchart of partial classification processing. The partial classification processing is performed if a scene cannot be classified by the overall classification processing (“NO” in S104 in FIG. 8). As described in the following, the partial classification processing is processing for classifying the scene of the entire image by individually classifying the scenes of partial images into which the image to be classified is divided. Here, the partial classification processing is described also with reference to FIG. 9.

First, the partial classifying section 60 selects one sub-partial classifying section 61 from a plurality of sub-partial classifying sections 61 (S301). The partial classifying section 60 is provided with three sub-partial classifying sections 61. Each of the sub-partial classifying sections 61 classifies whether or not each of the 8×8=64 blocks of partial images into which the image to be classified is divided belong to a specific scene. The three sub-partial classifying sections 61 here classify sunset scenes, flower scenes, and autumnal scenes, respectively. The partial classifying section 60 selects the sub-partial classifying sections 61 in the order of sunset flower autumnal scene. Thus, at the start, the sub-partial classifying section 61 (sunset scene partial classifying section 61S) for classifying whether or not the partial images belong to a sunset scene is selected.

Next, the partial classifying section 60 references the classification target table (FIG. 11) and determines whether or not scene classification is to be performed using the selected sub-partial classifying section 61 (S302). Here, the partial classifying section 60 references the “negative” field in the “sunset scene” column in the classification target table, and judges “YES” if there is a zero and “NO” if there is a 1. It should be noted that if, during the overall classification processing, the sunset scene classifying section 51S has set a negative flag based on the first negative threshold or another sub-classifying section 51 has set a negative flag based on the second negative threshold, the judgment is “NO” in this step S302. If the judgment is “NO”, the partial classification processing with respect to sunset scenes is omitted, so that the speed of the partial classification processing is increased. However, for the sake of explanation, it is assumed that the judgment here is “YES.”

Next, the sub-partial classifying section 61 selects one partial image from the 8×8=64 blocks of partial images into which the image to be classified is divided (S303).

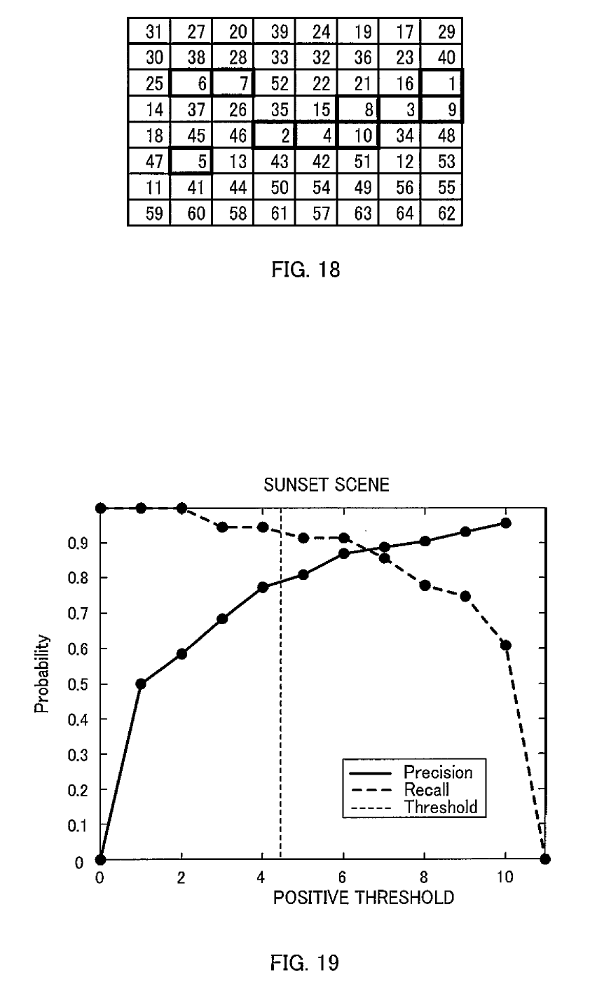

FIG. 18 is an explanatory diagram of the order in which the partial images are selected by the sunset scene partial classifying section 61S. If the scene of the entire image is classified based on partial images, it is preferable that the partial images used for classification are portions in which the photographic subject is present. For this reason, in the present embodiment, several thousand sample sunset scene images were prepared, each of the sunset scene images was divided into 8×8=64 blocks, blocks containing a partial sunset scene image (partial image of the sun and sky of a sunset scene) were extracted, and based on the location of the extracted blocks, the probability that a partial sunset scene image is present in each block was calculated. In the present embodiment, partial images are selected in descending order of the presence probability of the blocks. It should be noted that information about the selection sequence shown in the diagram is stored in the memory 23 as a part of the program.

In the case of a sunset scene image, the sky of the sunset scene often extends from around the center portion to the upper half portion of the image, so that the presence probability increases in blocks located in a region from around the center portion to the upper half portion. In addition, in the case of a sunset scene image, the lower ⅓ portion of the image often becomes dark due to backlight and it is usually impossible to determine based on a single partial image whether the image is a sunset scene or a night scene, so that the presence probability decreases in blocks located in the lower ⅓ portion. In the case of a flower image, the flower is usually positioned around the center portion of the image, so that the probability that a flower portion image is present around the center portion is high.

Next, the sub-partial classifying section 61 judges, based on the partial characteristic amounts of the partial image that has been selected, whether or not the selected partial image belongs to a specific scene (S304). The sub-partial classifying sections 61 employ a classification method using a support vector machine (SVM), as is the case with the sub-classifying sections 51 of the overall classifying section 50. A description of the support vector machine is provided later. If the discriminant equation has a positive value, it is judged that the partial image belongs to the specific scene, and the sub-partial classifying section 61 increments a positive count value. If the discriminant equation has a negative value, it is judged that the partial image does not belong to the specific scene, and the sub-partial classifying section 61 increments a negative count value.

Next, the sub-partial classifying section 61 judges whether or not the positive count value is larger than a positive threshold (S305). The positive count value indicates the number of partial images that have been judged to belong to the specific scene. If the positive count value is larger than the positive threshold (“YES” in S305), the sub-partial classifying section 61 judges that the image to be classified belongs to the specific scene, and sets a positive flag (S306). In this case, the partial classifying section 60 terminates the partial classification processing without performing classification by the subsequent sub-partial classifying sections 61. For example, when the image to be classified can be classified as a sunset scene image, the partial classifying section 60 terminates the partial classification processing without performing classification with respect to flower and autumnal scenes. In this case, the speed of the partial classification processing can be increased because classification by the subsequent sub-classifying sections 61 is omitted.

If the positive count value is not larger than the positive threshold (“NO” in S305), the sub-partial classifying section 61 cannot determine that the image to be classified belongs to the specific scene, and performs the processing of the subsequent step S307.

If the sum of the positive count value and the number of remaining partial images is smaller than the positive threshold (“YES” in S307), the sub-partial classifying section 61 proceeds to the process of S309. If the sum of the positive count value and the number of remaining partial images is smaller than the positive threshold, it is impossible for the positive count value to become larger than the positive threshold even if the positive count value is incremented by all of the remaining partial images, so that classification with the support vector machine for the remaining partial images is omitted by advancing the process to S309. As a result, the speed of the partial classification processing can be increased.

If the sub-partial classifying section 61 judges “NO” in S307, the sub-partial classifying section 61 judges whether or not there is a subsequent partial image (S308). In the present embodiment, not all of the 64 partial images into which the image to be classified is divided are selected sequentially. Only the top-ten partial images outlined by bold lines in FIG. 18 are selected sequentially. For this reason, when classification of the tenth partial image is finished, the sub-partial classifying section 61 judges in S308 that there is no subsequent partial image. (“The number of partial images remaining” in S307 is also determined with consideration to this aspect.)

FIG. 19 shows graphs of Recall and Precision when a sunset scene image is classified using only the top-ten partial images. When the positive threshold is set as shown in this diagram, the ratio of correct answers (Precision) can be set to about 80% and the recall ratio (Recall) can be set to about 90%, so that classification can be performed with high precision.

In the present embodiment, classification of the sunset scene image is performed based on only ten partial images. Accordingly, in the present embodiment, the speed of the partial classification processing can be made higher than in the case of performing classification of the sunset scene image using all of the 64 partial images.

Moreover, in the present embodiment, classification of the sunset scene image is performed using the top-ten partial images with a high presence probability of containing a partial sunset scene image. Accordingly, in the present embodiment, both Recall and Precision can be set to higher levels than in the case of performing classification of the sunset scene image using ten partial images that have been extracted regardless of the presence probability.

Furthermore, in the present embodiment, the partial images are selected in descending order of the presence probability of containing a partial sunset scene image. As a result, there is a greater likelihood of judging “YES” at an early stage in S305. Accordingly, the speed of the partial classification processing can be higher than in the case of selecting partial images in the order regardless of whether the presence probability is high or low.

If the judgment is “YES” in S307 or if it is judged in S308 that there is no subsequent partial image, then the sub-partial classifying section 61 judges whether or not the negative count value is larger than a negative threshold (S309). This negative threshold has substantially the same function as the negative threshold (S206 in FIG. 10) in the above-described overall classification processing, and thus a detailed description thereof is omitted. If the judgment is “YES” in S309, a negative flag is set as in the case of S207 in FIG. 10.

If the judgment is “NO” in S302, if it is “NO” in S309, or if the process of S310 is finished, the partial classifying section 60 judges whether or not there is a subsequent sub-partial classifying section 61 (S311). If the processing by the sunset scene partial classifying section 61S has been finished, there are remaining sub-partial classifying sections 61, i.e., the flower partial classifying section 61F and the autumnal partial classifying section 61R, so that the partial classifying section 60 judges in S311 that there is a subsequent sub-partial classifying section 61.

Then, if the process of S306 is finished (if it is judged that the image to be classified belongs to a specific scene) or if it is judged in S311 that there is no subsequent sub-partial classifying section 61 (if it cannot be judged that the image to be classified belongs to a specific scene), the partial classifying section 60 terminates the partial classification processing.

As already described above, when the partial classification processing is terminated, the scene classification section 33 judges whether or not scene classification could be accomplished by the partial classification processing (S106 in FIG. 8). At this time, the scene classification section 33 references the classification target table shown in FIG. 11 and judges whether or not there is a “1” among the “positive” fields.

If the scene could be classified by partial classification processing (“YES” in S106), then the integrative classification processing is omitted. Thus, the speed of the scene classification processing is increased.

### Support Vector Machine

Before describing the integrative classification processing, the support vector machine (SVM) used by the sub-classifying sections 51 in the overall classification processing and the sub-partial classifying sections 61 in the partial classification processing is described.

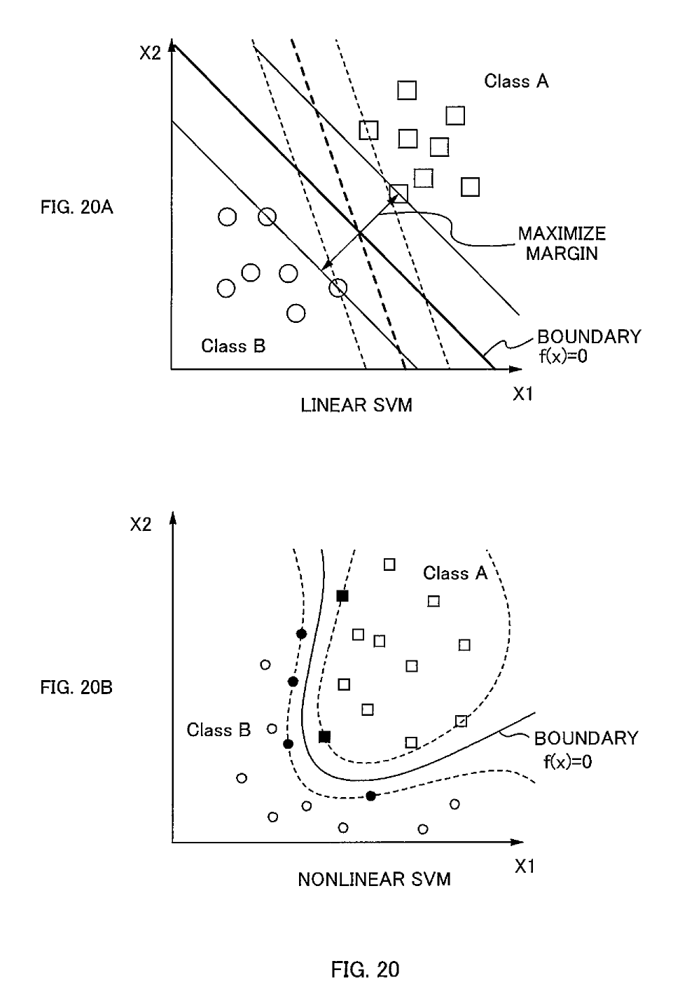

FIG. 20A is an explanatory diagram of classification using a linear support vector machine. Here, learning samples are shown in a two-dimensional space defined by two characteristic amounts x1 and x2. The learning samples are divided into two classes A and B. In the diagram, the samples belonging to the class A are represented by circles, and the samples belonging to the class B are represented by squares.

As a result of learning using the learning samples, a boundary that divides the two-dimensional space into two portions is defined. The boundary is defined as <w·x>+b=0 (where x=(x1, x2), w represents a weight vector, and <w·x> represents the inner product of w and x). However, the boundary is defined as a result of learning using the learning samples so as to maximize the margin. That is to say, in this diagram, the boundary is not the bold dotted line but the bold solid line.

Classification is performed using the discriminant equation f(x)=<w·x>+b. If a certain input x (this input x is separate from the learning samples) satisfies f(x)>0, it is discriminated as belonging to the class A, and if f(x)<0, it is discriminated as belonging to the class B.

Here, classification using the two-dimensional space is described, however there is no limitation to this (i.e., more than two characteristic amounts may be used). In this case, the boundary is defined as a hyperplane.

There are cases where separation between the two classes cannot be achieved by using a linear function. In such cases, when classification is performed with a linear support vector machine, the precision of the classification result decreases. To address this problem, the characteristic amounts in the input space are nonlinearly transformed, or in other words, nonlinearly mapped from the input space into a certain characteristics space, and thus separation in the characteristics space can be achieved by using a linear function. Nonlinear support vector machines use this method.

FIG. 20B is an explanatory diagram of classification using a kernel function. Here, learning samples are shown in a two-dimensional space defined by two characteristic amounts x1 and x2. If a characteristics space as shown in FIG. 20A is obtained by nonlinear mapping from the input space shown in FIG. 20B, then separation between the two classes can be achieved by using a linear function. An inverse mapping of the boundary in the characteristics space is the boundary shown in FIG. 20B, where the boundary is defined so as to maximize the margin in this characteristics space. As a result, the boundary is nonlinear as shown in FIG. 20B.

The present embodiment uses a Gauss kernel function, so that the discriminant equation f(x) is as follows (where M represents the number of characteristic amounts, N represents the number of learning samples (or the number of learning samples that contribute to the boundary), wᵢ represents a weight factor, yⱼ represents the characteristic amount of the learning samples, and xⱼ represents the characteristic amount of an input x.)

$$f ( x ) = {{\sum }_{i}}^{N} {w}_{i} exp ( - {{\sum }_{j}}^{M} \frac{{( {x}_{j} - {y}_{j} )}^{2}}{2 {σ}^{2}} ) \qquad Equation 1$$

If a given input x (separate from the learning samples) satisfies f(x)>0, it is discriminated as belonging to the class A, and if f(x)<0, it is discriminated as belonging to the class B. Moreover, the larger the value of the discriminant equation f(x) is, the higher the probability that the input x (which is separate from the learning samples) belongs to the class A is. Conversely, the smaller the value of the discriminant equation f(x) is, the lower the probability that the input x (which is separate from the learning samples) belongs to the class A is. The sub-classifying sections 51 in the overall classification processing and the sub-partial classifying sections 61 in the partial classification processing, which are described above, utilize the value of the discriminant equation f(x) of the above-described support vector machine.

It should be noted that evaluation samples are prepared separately from the learning samples. The above-described graphs of Recall and Precision are based on the classification result with respect to the evaluation samples.

### Integrative Classification Processing

In the above-described overall classification processing and partial classification processing, the positive thresholds in the sub-classifying sections 51 and the sub-partial classifying sections 61 are set to relatively high values to set Precision (ratio of correct answers) to a rather high level. The reason for this is that when, for example, the ratio of correct answers of the landscape classifying section 51L of the overall classification section is set to a low level, a problem occurs in that the landscape classifying section 51L may misclassify an autumnal image as a landscape image and terminate the overall classification processing before classification by the autumnal classifying section SIR is performed. In the present embodiment, Precision (the ratio of correct answers) is set to a rather high level, and thus an image belonging to a specific scene is classified by the sub-classifying section 51 (or the sub-partial classifying section 61) with respect to that specific scene (for example, an autumnal image is classified by the autumnal classifying section 51R (or the autumnal partial classifying section 61R)).

However, when Precision (the ratio of correct answers) of the overall classification processing and the partial classification processing is set to a rather high level, the possibility that scene classification cannot be accomplished by the overall classification processing and the partial classification processing increases. To address this problem, in the present embodiment, when scene classification could not be accomplished by the overall classification processing and the partial classification processing, the integrative classification processing described in the following is performed.

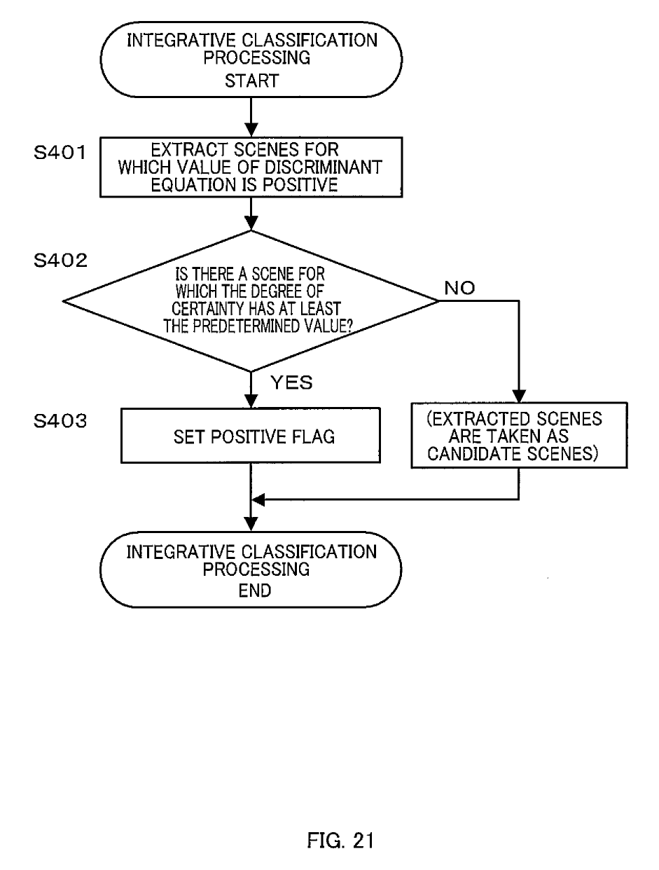

FIG. 21 is a flowchart of integrative classification processing. As described in the following, the integrative classification processing selects a scene with the highest degree of certainty and having at least a predetermined degree of certainty (for example equal to or more than 90%) based on the value of the discriminant equation of the sub-classifying sections 51 in the overall classification processing.

First, the integrative classifying section 70 extracts, based on the values of the discriminant equations of the five sub-classifying sections 51, a scene for which the value of the discriminant equation is positive (S401). At this time, the value of the discriminant equation calculated by the sub-classifying sections 51 during the overall classification processing is used.

Next, the integrative classifying section 70 judges whether or not there is a scene for which the degree of certainty has equal to or more than a predetermined value (S402). Here, the degree of certainty indicates the probability that the image to be classified belongs to certain scenes and is determined from the value of the discriminant equation. More specifically, the integrative classifying section 70 is provided with a table indicating the relation between values of the discriminant equation and Precision. The Precision corresponding to the value of the discriminant equation is derived from this table and this value of Precision is taken as the degree of certainty. It should be noted that the predetermined value is set for example to 90%, which is a value that is lower than Precision (97.5%), which is set by the positive thresholds of the overall classifying section and the partial Classifying sections. However, the degree of certainty does not have to be Precision and it is also possible to use the value of the discriminant equation as the degree of certainty.

If there is a scene for which the degree of certainty has at least the predetermined value (“YES” in S402), then a positive flag is set in the column of that scene (S403), and the integrative classification processing is terminated. It should be noted that when a scene with a degree of certainty of equal to or more than 90% is extracted, then a plurality of scenes will not be extracted. This is so because if the degree of certainty of a given scene is high, then the degree of certainty of other scenes is inevitably low.

On the other hand, if there is no scene for which the degree of certainty has equal to or more than the predetermined value (“NO” in S402), the integrative classification processing is terminated without setting a positive flag. Thus, there is still no scene for which 1 is set in the “positive” fields of the classification target table shown in FIG. 11. That is to say, the scene to which the image to be classified belongs could not be classified.

As already described above, when the integrative classification processing is terminated, the scene classification section 33 judges whether or not scene classification could be accomplished by the integrative classification processing (S108 in FIG. 8). At this time, the scene classification section 33 references the classification target table shown in FIG. 11 and judges whether or not there is a “1” among the “positive” fields. If the judgment is “YES” in S402, then also the judgment in S108 is “YES”. On the other hand, if the judgment is “NO” in S402, then also the judgment in S108 is “NO”.

In the present embodiment, if the judgment is “NO” in S108 of FIG. 8, that is, if the judgment is “NO” in S402 in FIG. 21, then all scenes extracted in S401 are stored as scene candidates in the result storage sections 31B.

Display with the Display Section

Overview

As described above, the user can set a shooting mode using the mode setting dial 2A. Then, the digital still camera 2 determines shooting conditions (exposure time, ISO sensitivity, etc.) based on, for example, the set shooting mode and the result of photometry when taking a picture and photographs the photographic subject under the determined shooting conditions. After taking the picture, the digital still camera 2 stores shooting data indicating the shooting conditions when the picture was taken together with image data in the memory card 6 as an image file.

There are instances where the user forgets to set the shooting mode and thus a picture is taken while a shooting mode unsuitable for the shooting conditions remains set. For example, a daytime landscape scene may be photographed with the night scene mode still being set. As a result, in this case, although the image data in the image file is an image of a daytime landscape scene, data indicating the night scene mode is stored in the shooting data (for example, the scene capture type data shown in FIG. 5 is set to “3”). In this case, when the image data is enhanced based on improper scene capture type data, printing may be carried out with an image quality that is undesirable for the user.

On the other hand, sometimes a print with the image quality desired by the user is not obtained even if the image data is enhanced based on the result of the classification processing (face detection processing and scene classification processing). For example, if a misclassification occurs during the classification processing, a print with the image quality desired by the user may not be obtained. Moreover, also when the user overrides the set shooting mode in order to attain a special effect, and the image data is enhanced based on the classification result by the printer, printing cannot be performed as intended by the user.

Accordingly, a confirmation screen prompting the user to make a confirmation is displayed in the present embodiment. More specifically, as explained further below, if the result of the classification processing does not match the scene indicated by the scene information of the supplemental data of the image file (scene capture type data or shooting mode data), then a confirmation screen is displayed on the display section 16 of the panel section 15.

### First Embodiment

In the first embodiment, direct printing of a plurality of image files is carried out. As explained further below, in this first embodiment, an image of all image files is displayed on the confirmation screen, and the printing is started after terminating the confirmation with the confirmation screen.

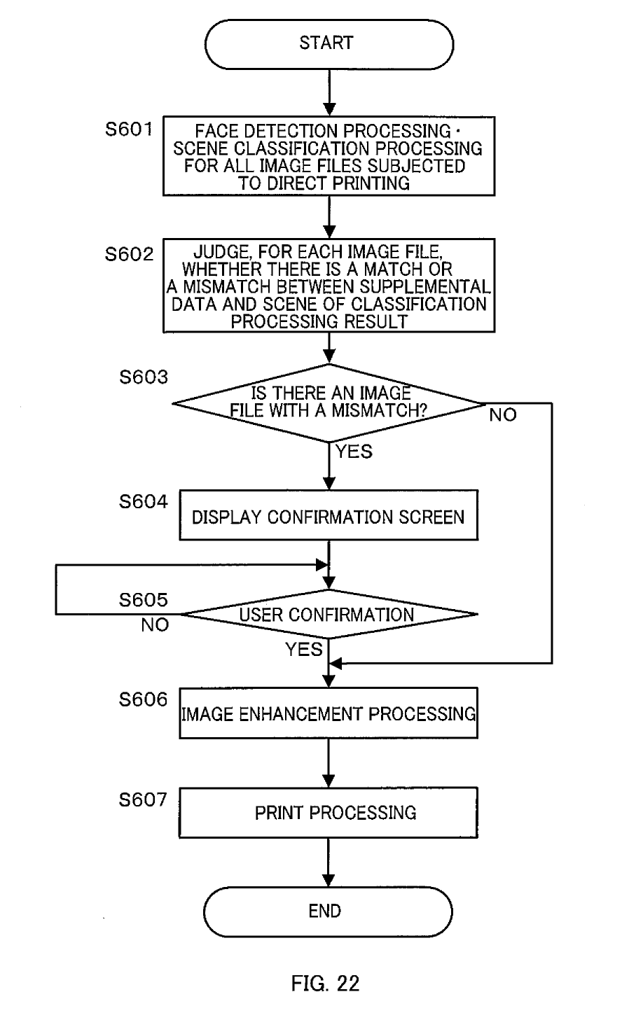

FIG. 22 is a flowchart showing the process flow of direct printing according to the first embodiment. The process steps are realized by the printer controller 20 based on a program stored in the memory 23.

First, the printer controller 20 subjects all image files to be printed by direct printing to face detection processing and scene classification processing (S601). These processes have already been explained above, so that further explanations thereof are omitted.

Next, the printer controller 20 judges for each image file to be subjected to direct printing whether or not the scene indicated by the supplemental data (scene capture type data, shooting mode data) matches the scene indicated by the classification processing result (S602). If a plurality of scene candidates are included in the classification processing result, then the judgment is performed using the scene candidate with the highest degree of certainty.

Next, the printer controller 20 judges whether there is at least one image file for which the two scenes (the scene indicated by the supplemental data and the scene indicated by the classification result) do not match (S603). If the two scenes (the scene indicated by the supplemental data and the scene indicated by the classification result) match for all image files to be subjected to direct printing (“NO” in S603), then there is no need to let the user confirm anything, so that the processing advances to S606. Accordingly, no confirmation screen is displayed, so that the processing time until printing begins can be shortened.

If there is at least one image file for which the two scenes (the scene indicated by the supplemental data and the scene indicated by the classification result) do not match (“YES” in S603), then the printer controller 20 displays the confirmation screen on the display section 16 (S604).

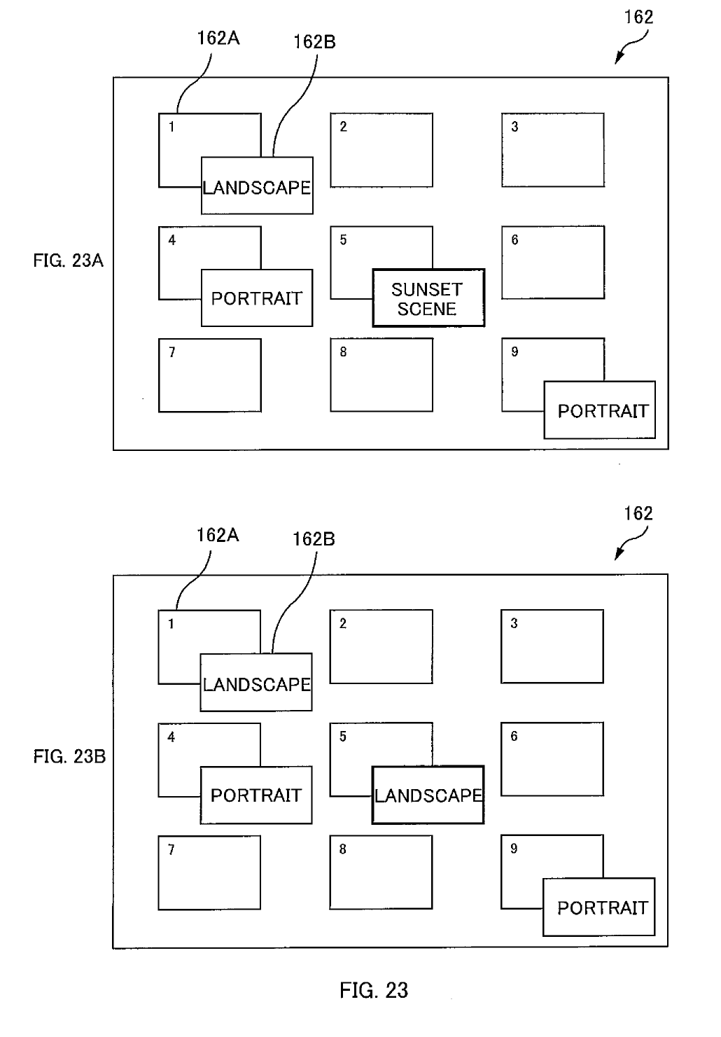

FIGS. 23A and 23B are explanatory diagrams of examples of a confirmation screen according to the first embodiment.

This confirmation screen 162 displays nine images 162A (in the figures, only rectangular frames are shown, but in reality, images are displayed within these frames). These nine images 162A are images of nine image files from the plurality of image files to be subjected to direct printing. Since the space in which images can be displayed is small, the images 162A are displayed using the thumbnail image data of the image files (see FIG. 3). Also, since the displayed images are small, it is difficult for the user to evaluate the image quality, so that the thumbnail image data is not subjected to any image enhancement. A numeral is written in the upper left of each of the images 162A, in the temporal order in which the images have been taken or in the order of the data names of the image files. In the following explanations, the images are specified using these numerals. For example, of the nine images in the confirmation screen, the image in the upper left is referred to as “first image”, and the image file corresponding to this image is referred to as “first image file”.

The printer controller 20 displays those images 162A, in which the two scenes (the scene indicated by the supplemental data and the scene indicated by the classification result) match in S602 mentioned above, without adding marks 162B to them. The printer controller 20 displays those images 162B, in which the two scenes (the scene indicated by the supplemental data and the scene indicated by the classification result) do not match in S602 mentioned above, with added marks 162B. Thus, the user can easily grasp, from the presence or absence of the marks 162B for which of the images the two scenes (the scene indicated by the supplemental data and the scene indicated by the classification result) do not match.

In the confirmation screen 162 shown in the figures, marks 162B are displayed to the lower right of the first, fourth, fifth, and ninths images. Therefore, it can be seen that the scene of the supplemental data and the scene of the classification result do not match for the first, fourth, fifth, and ninth image files. On the other hand, no mark 162B is displayed for the second, third, and sixth to eighth images. Therefore, it can be seen that the scene of the supplemental data and the scene of the classification result match for the second, third, and sixth to eighth image files.

The scene of the classification processing result is displayed within the each mark 162B. If a plurality of scene candidates are included in the classification processing result, then the scene candidate with the highest degree of certainty is indicated within the marks 162B. For example, the scene of the classification processing result of the first image file (or the scene candidate with the highest degree of certainty) of the first image file is “landscape”.

In the first embodiment, no mark 162B is appended to the images for which the scene of the supplemental data matches the scene of the classification result. Thus, the images for which the two scenes (the scene indicated by the supplemental data and the scene indicated by the classification result) do not match stand out. On the other hand, when marks 162B are not appended, the result of the classification process for those images is not displayed in the confirmation screen 162. However, if the two scenes (the scene indicated by the supplemental data and the scene indicated by the classification result) match, then a confirmation by the user should be unnecessary anyway, so that it is no problem not to display the classification processing results.

By operating the input section 17 while viewing the confirmation screen, the user decides for each image whether to make enhancements based on the scenes of the supplemental data or whether to make enhancements based on the scenes of the classification processing results. For example, when the user selects the mark 162B of the fifth image 162A by operating the input section 17, then the mark 162B is displayed with a bold frame, as shown in FIG. 23A. By operating the input section 17 again in this state, the user can switch the scene displayed in the mark 162B. At this time, the printer controller 20 displays the scene of the supplemental data, and if there are a plurality of scene candidates, displays the other scene candidates one after the other in the mark 162B, in accordance with the user operation. FIG. 23B shows the state when “landscape”, which is the scene of the supplemental data, is displayed in the mark 162B, in accordance with the user operation. Thus, by displaying the scene of the classification processing result and the scene of the supplemental data one after the other, the selection options for the user are limited, which makes the operation easier for the user. If the user were given the option to select the desired scene from all scenes (for example, all scenes in FIG. 7), then the selection range for the user would be too wide, and the usability would not be very high.

After the first to ninth image files have been confirmed on the confirmation screen, the printer controller 20 displays a further confirmation screen with the tenth to eighteenths image files. Thus, the user can confirm the remaining image files in a similar manner.

When the user pushes an enter button (not shown in the drawings) of the input section 17 (“YES” in S605), the printer controller 20 enhances the image data with the enhancement modes corresponding to the user's selections (S606). If this enter button is pressed in the state shown in FIG. 23B, then the image data other than for the fifth image are enhanced based on the scenes of the classification processing result (or the scene candidate with the highest degree of certainty in the case of multiple scene candidates), and the image data of the fifth image is enhanced with the landscape mode based on the scene of the supplemental data (see FIG. 7).

The confirmation screen is displayed until the user enters a confirmation (“NO” in S605). When the user enters the confirmation (“YES” in S605), the printer controller 20 enhances the image data with the enhancement modes corresponding to the user's selections (S606). However, it is also suitable to enhance the image data with the enhancement mode corresponding to the scenes selected by the initial settings (here, the scenes of the classification processing result) when a predetermined period of time (for example 20 sec) has expired after displaying the confirmation screen, even if there is no confirmation input by the user. Thus, it is possible to continue the processing even when the user has left the printer. The scenes selected by the initial settings may change in accordance with the degree of certainty of the classification processing results, but they may also be determined in advance such that ordinarily the scenes of the classification processing results are selected regardless of the degree of certainty.

After the image enhancement processing, the printer controller 20 prints the image based on the enhanced image data (S607). Thus, printed images with an image quality as desired by the user are obtained.

### Second Embodiment

In the second embodiment, the confirmation screen displays only an image of the image files for which the scene of the supplemental data does not match the scene of the classification processing result, and performs the printing of those files for which there is no such mismatch in advance. That is to say, compared to the case of the first embodiment, the image files that are displayed on the confirmation screen are different and the timing when the printing process begins is also different.

In the following explanations, it is assumed that the first to ninth image files are subjected to direct printing. Like in the first embodiment, the scene of the supplemental data does not match the scene of the classification result for the first, fourth, fifth, and ninth image files, whereas the scene of the supplemental data matches the scene of the classification result for the second, third, and sixth to eighth image files.

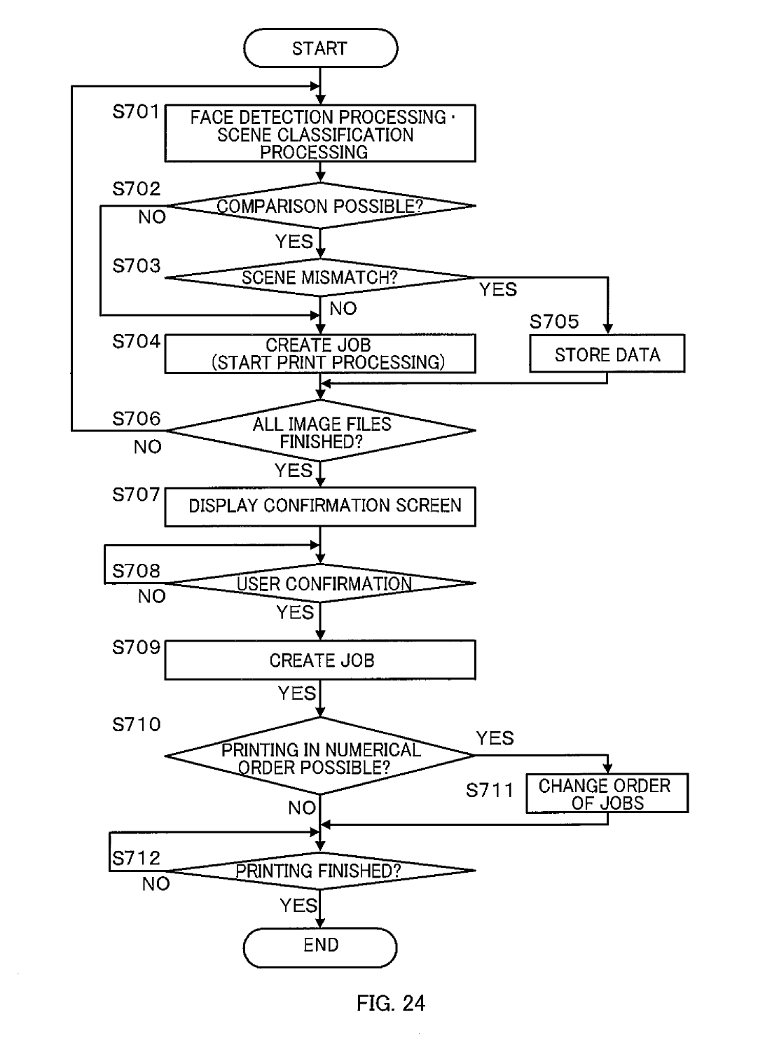

FIG. 24 is a flowchart showing the process flow of direct printing according to the second embodiment. The process steps are realized by the printer controller 20 based on a program stored in the memory 23.

First, the printer controller 20 obtains the first image file from the plurality of image files to be printed by direct printing, and subjects it to face detection processing and scene classification processing (S701). These processes have already been explained above, so that further explanations thereof are omitted.

Next, the printer controller 20 judges whether the scene indicated by the supplemental data can be compared with the scene indicated by the classification processing result (S702). If a plurality of scene candidates are included in the classification processing result, then the judgment is performed using the scene candidate with the highest degree of certainty.

It should be noted that the judgment method in S702 in the case where the scene capture type data is used for the judgment of a mismatch in the following step S703 differs from the case where the shooting mode data, which is MakerNote data, is used.

If the scene capture type data is used in S703, and the scene capture type data is none of “portrait”, “landscape”, and “night scene”, for example when the scene capture type data is “0” (see FIG. 5), then it is not possible to compare it with the classification processing result in S703, so that the judgment in S702 is “NO”. Also if the classification processing result is none of “portrait”, “landscape”, and “night scene”, then it is not possible to compare it with the scene capture type data in S703, so that the judgment in S702 is “NO”. For example, if the classification processing result is “sunset scene”, then the judgment in S702 is “NO”.

If the shooting mode data is used in S703, and the shooting mode data is none of “portrait”, “sunset scene”, “landscape”, and “night scene”, for example when the shooting mode data is “3 (close-up)” for example (see FIG. 5), then it is not possible to compare it with the classification processing result in S703, so that the judgment in S702 is “NO”. Also if the classification processing result is none of “portrait”, “landscape”, “sunset scene”, and “night scene”, then it is not possible to compare it with the scene capture type data in S703, so that the judgment in S702 is “NO”.

If the judgment in S702 is “YES”, then the printer controller 20 judges whether there is a mismatch between the scene indicated by the supplemental data (scene capture type data, shooting mode data) and the scene indicated by the classification processing result (S703). If a plurality of scene candidates are included in the classification processing result, then the judgment is performed using the scene candidate with the highest degree of certainty.

If the result of S703 is that there is a mismatch (YES), then the number of that image file and for example the classification processing result are stored in the memory 23 (S705). Then, the process advances to S706.

If the result of S703 is that there is no mismatch (NO), then the printer controller 20 creates the print job (referred to simply as “job” in the following) (S704). As for the content of that job, the image data is enhanced based on the scene of the classification processing result, and the printing process is carried out based on the enhanced image data. If a plurality of jobs have accumulated, then the printer controller 20 executes those jobs in order according to their degree of priority. When executing a job, the image data is enhanced based on a predetermined scene (here, the scene of the classification processing result) in accordance with the content of that job, and the printing process is carried out based on the enhanced image data. It should be noted that the printer controller 20 performs the processing in FIG. 24 in parallel also while executing a job.

If “YES” is judged in S702 for the first image file, and “YES” is judged in S703, then the printer controller 20 stores the image file number and the classification processing result (here, “landscape”, if there are a plurality of scene candidates, those scene candidates) in the memory 23 (S705).

Next, the second to ninth image files are still left, so that “NO” is judged in S706, and the processing of S701 is carried out for the second image file.

If “YES” is judged in S702 and “NO” is judged in S703 for the second image file, the printer controller 20 creates a job for the second image file (S704). At this time, there is no other job, so that after creating the job, this job is executed immediately. That is to say, the image data of the second image file is subjected to an enhancement process, and the printing process is started based on the enhanced image data.

In this manner, the processing of S701 to S706 is carried out also for the remaining third to ninth image files. It should be noted that while the job of the second image file is executed, the printer controller 20 performs the processing of S701 to S706 for the third image file in parallel.

After the processing of S705 for the ninth image file has been performed, there are no further image files remaining, so that the printer controller 20 judges “YES” in S706. Then, the printer controller 20 displays the confirmation screen (S707).

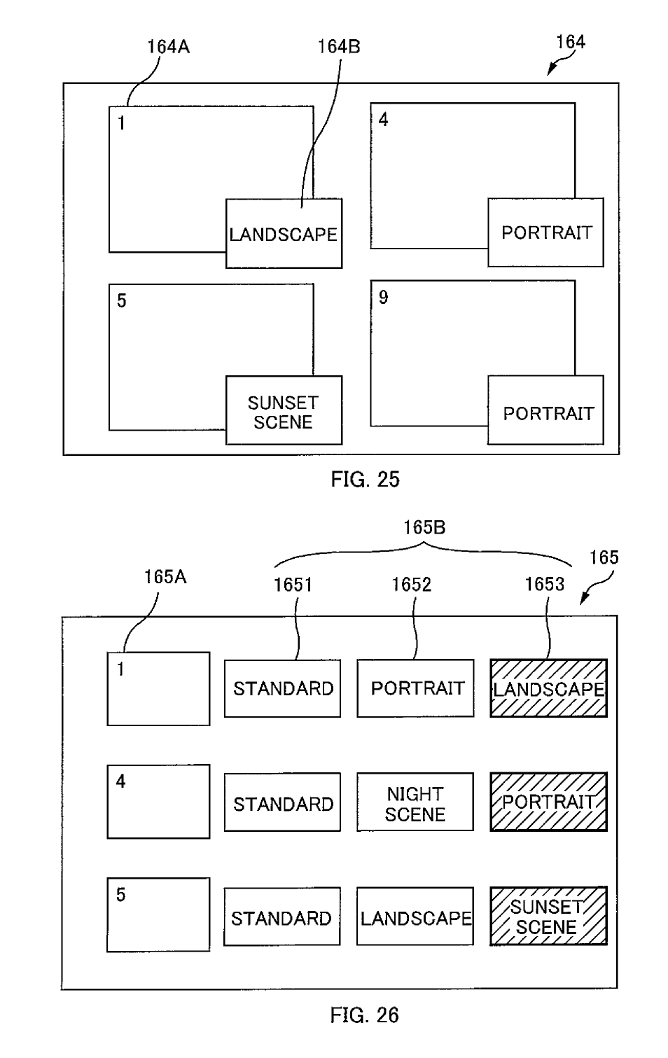

FIG. 25 is an explanatory diagram showing an example of a confirmation screen 164 according to the second embodiment.

This confirmation screen 164 displays four images 164A (in the figures, only rectangular frames are shown, but in reality, images are displayed within these frames). Based on the data stored in S705, the printer controller 20 judges which images should be displayed on the confirmation screen 164. The four images 164A displayed on the confirmation screen 164 are the first, fourth, fifth, and ninth images, for which it has been judged in S703 that the scene indicated by the supplemental data (scene capture type data, shooting mode data) does not match the scene indicated by the classification processing result.

Compared to the first embodiment explained above, only the images for which there is a mismatch are displayed in the second embodiment, so that the user can more easily grasp the images that need to be confirmed. Also, in the second embodiment, only the images for which there is a mismatch between the two scenes (the scene indicated by the supplemental data and the scene indicated by the classification result) are displayed, so that the space in which the images 164A can be displayed is enlarged. Therefore, the images 164A may be displayed using thumbnail image data, but it is also possible to display them after enhancing the image data. If the images 164A are displayed after enhancing the image data, then they are enhanced in accordance with the scene indicated in the marks 164B to the lower right of the images 164A. Thus, the content of the enhancement performed on the images 164A matches the content indicated by the marks 164B to the lower right of the images 164A.

Like in the first embodiment, by operating the input section 17 while viewing the confirmation screen 164, the user decides whether to make enhancements based on the scenes of the supplemental data or whether to make enhancements based on the scenes of the classification processing results, for each image. If the images 164A are displayed after enhancing the image data, then the printer controller 20 switches and displays the enhancement performed on the images 164A each time the scene in the mark 164B is switched. For example, when the scene indicated by the mark 164B of the fifth image 164A is switched from “sunset scene” (scene of the classification processing result) to “landscape” (scene of the supplemental data), then the fifth image 164A is switched from an image enhanced with the sunset mode to an image enhanced with the landscape mode. Thus, the result of the enhancement can be easily confirmed by the user.

The confirmation screen is displayed until the user enters a confirmation (“No” in S708). However, it is also possible to advance to the next process after a predetermined period of time (for example 20 sec) has passed after the display of the confirmation screen, even if there is no entry of a confirmation by the user. Thus, it is possible to continue the processing even when the user has left the printer. In this case, the scenes selected by the initial settings are regarded as selected by the user. The scenes selected by the initial settings may change in accordance with the degree of certainty of the classification processing results, but they may also be determined in advance such that ordinarily the scenes of the classification processing results are selected regardless of the degree of certainty.

In the second embodiment, printing is already started while the user performs operations on the confirmation screen. In the above-described first embodiment, the start of the printing is delayed if the confirmation by the user takes time, but with the second embodiment, the printing is started (the printing of at least the second image is started) during the display of the confirmation screen, so that the time until the printing is finished is shortened.

When the user pushes an enter button (not shown in the drawings) of the input section 17 (“YES” in S708), the printer controller 20 creates jobs for printing the first, fourth, fifth, and ninth images (S709). As for the content of those jobs, the image data is enhanced based on the scenes selected by the user, and the printing process is carried out based on the enhanced image data.

Next, the printer controller 20 judges whether it is in a state in which printing can be performed in numerical order (S710). More specifically, if the smallest number of the image files for which a job has been created in S709 is larger than the number of the image for which printing has already started, then the printer controller 20 judges that it is in a state in which printing can be performed in numerical order. Here, the smallest number of the image files for which jobs have been created in S709 (first, fourth, fifth and ninth image files) is the number 1, and printing has already started for the second image, so that the judgment of S710 is “NO”.

If the two scenes (the scene indicated by the supplemental data and the scene indicated by the classification result) for the first image file would have matched, then jobs for printing the first to third images would be created in S704, and the printing of the first image would start. Ordinarily, it takes several seconds to several dozen seconds to print one image, so that if the user is fast to operate the confirmation screen, the jobs of the fourth, fifth, and ninth image files are created (S709) before the printing of the first to third images has finished (before starting the printing of the sixth image). In this case, the printer controller 20 judges “YES” in S710, the order of jobs is changed (S711), and the priority order of the jobs is set to the order of the numbers of the image files. Thus, after printing the third image, the printer 4 prints the fourth image, and not the sixth image. Then, the user can obtain the printed images in the order of the numbers of the image files.

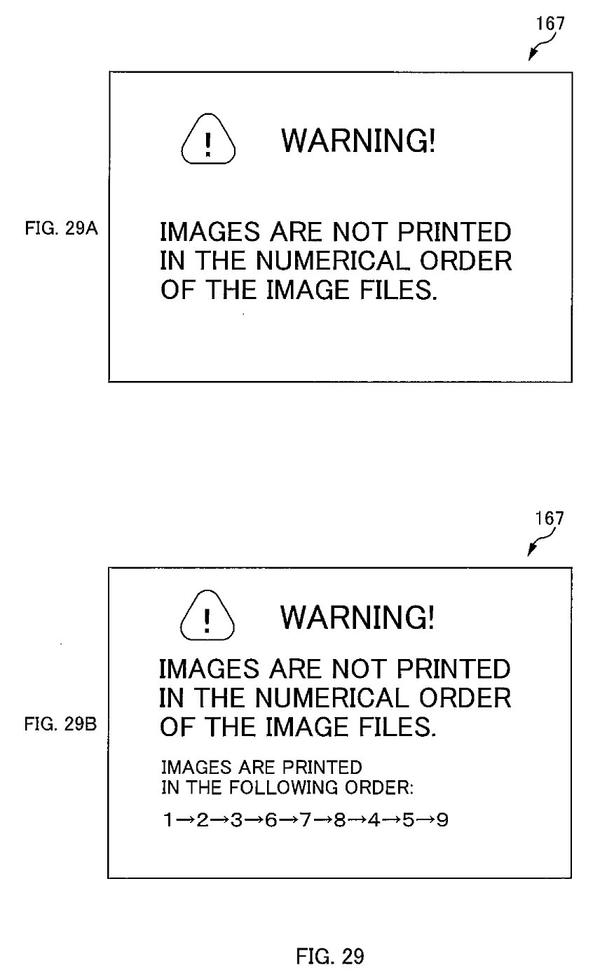

It should be noted that if the judgment in S710 is “NO”, then the printer 4 does not print the images in the order of the numbers of the image files, so that the printer controller 20 may also display a warning screen 167 to indicate this to the user on the display section 16, as shown in FIG. 29A. Furthermore, as shown in FIG. 29B, if the printer controller 20 displays the printing order in this warning screen 167, then this may be useful when the user wants to sort the order of the printed images.

Then, the printer controller 20 executes the accumulated jobs in accordance with the priority order, and terminates the process when all jobs have been executed (“YES” in S712).

Other Confirmation Screens

FIG. 26 is an explanatory diagram of another confirmation screen. This confirmation screen 165 differs from the confirmation screen 164 of FIG. 25 in that three marks 1651 to 1653 are provided for each image.

Three images 165A are displayed in this confirmation screen 165. Like in the case of the above-described screen 164, the printer controller 20 judges which images should be displayed on the confirmation screen 165, based on the data stored in S705. The three images 164A displayed on the confirmation screen 165 are the first, fourth, and fifth images, for which it has been judged in S703 that the scene indicated by the supplemental data (scene capture type data, shooting mode data) does not match the scene indicated by the classification processing result. The information concerning the ninth image is displayed by switching the confirmation screen through a user operation.

Also in this confirmation screen 165, only images for which the two scenes (the scene indicated by the supplemental data and the scene indicated by the classification result) do not match are displayed, so that the images that need to be confirmed can be easily grasped by the user. However, compared to the above-described confirmation screen 164, the space in which the images 165A can be displayed is small, so that the images 165A are displayed using the thumbnail image data of the image files (see FIG. 3). Also, since the displayed images are small, it is difficult for the user to evaluate the image quality, so that the thumbnail image data is not subjected to any image enhancement.

To the right of the images 165, three marks 1651 to 1653 are displayed in association with the respective images. The three marks are, in order from the left, a mark indicating an enhancement in the standard mode (enhancement by “other” in FIG. 7), a mark indicating the scene of the supplemental data, and a mark indicating the classification processing result. In the above-described confirmation screen 164, the user has switched the scene in the mark, but in this confirmation screen 165, the user selects one of the marks, and the printer controller 20 enhances the image based on the scene corresponding to the user's selection.

The confirmation screen 165 contains marks indicating that an enhancement in the standard mode is performed (enhancement by “other” in FIG. 7), but it is also possible not to provide such marks. Moreover, if there is space leftover for displaying marks, and there are a plurality of scene candidates, then it is also possible to display marks indicating each of those scene candidates.

Also with this confirmation screen 165, compared to the first embodiment explained above, only the images for which there is a mismatch are displayed, so that the user can more easily grasp the images that need to be confirmed. Also, with the second embodiment, only the images for which there is a mismatch between the two scenes (the scene indicated by the supplemental data and the scene indicated by the classification result) are displayed, so that the space in which the marks 165B can be displayed is enlarged. Therefore, the information amount that can be presented to the user on the confirmation screen can be increased.

### Addition of Scene Information to Supplemental Data

If the user selects a scene on the confirmation screen, it is possible to establish the scene that is desired by the user. Accordingly, in the first embodiment and the second embodiment, when the user has made a confirmation on the confirmation screen, the printer controller 20 stores the scene that has been selected by the user in the supplemental data of the image file. Here, the case is explained where the user has selected the scene of the classification processing result on the confirmation screen.

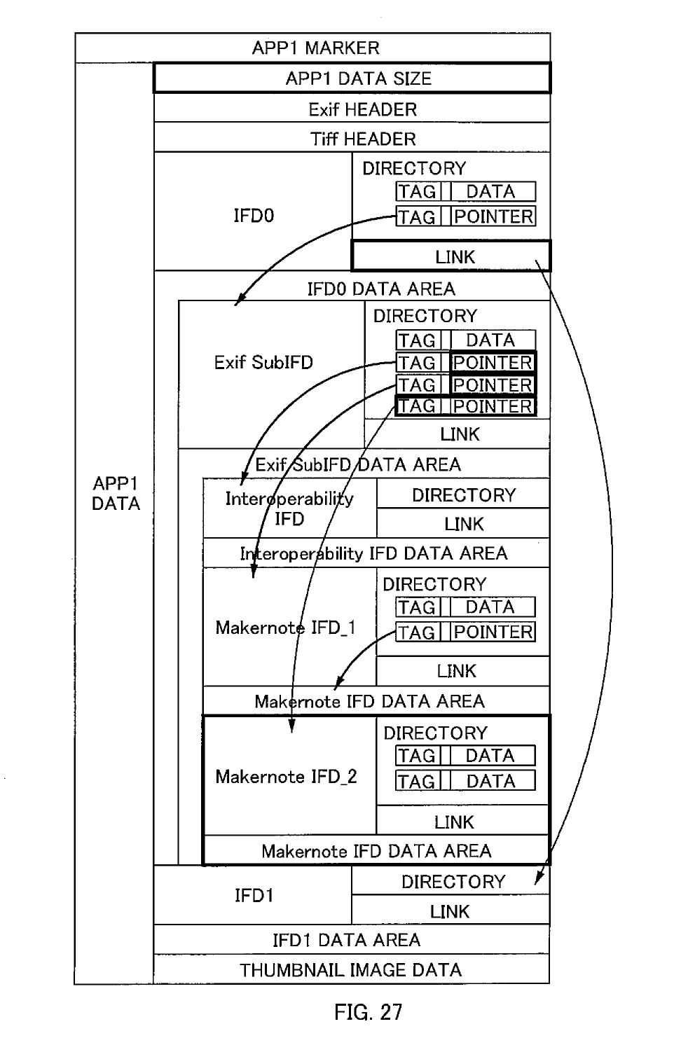

FIG. 27 is an explanatory diagram of a configuration of an APP1 segment when the classification result is added to the supplemental data. In FIG. 27, portions different from those of the image file shown in FIG. 3 are indicated by bold lines.

Compared to the image file shown in FIG. 3, the image file shown in FIG. 27 has an additional Makernote ITD added to it. Information about the classification processing result is stored in this second Makernote IFD.

Moreover, a new directory entry is also added to the Exif SubIFD. The additional directory entry is constituted by a tag indicating the second Makernote IFD and a pointer pointing to the storage location of the second Makernote IFD.

Furthermore, since the storage location of the Exif SubIFD data area is displaced as a result of adding the new directory entry to the Exif SubIFD, the pointer pointing to the storage location of the Exif SubIFD data area is changed.

Furthermore, since the IFD1 area is displaced as a result of adding the second Makernote IFD, the link located in the IFD0 and indicating the position of the IFD1 is also changed. Furthermore, since there is a change in the size of the data area of APP1 as a result of adding the second Makernote IFD, the size of the data area of APP1 is also changed.

By saving the scene selected by the user (in this case, the scene of the classification processing result) in this manner in the additional data of the image file, it becomes unnecessary to perform classification processing or to display the confirmation screen again when printing the image of this image file. Moreover, when the user removes the memory card 6 from the printer 4 of the first or the second embodiment and inserts the memory card 6 into another printer, the image data can be enhanced appropriately even when this printer is a printer not having the scene classification processing function but performing automatic enhancement processing.

### Other Embodiments

The foregoing embodiments were described primarily with regard to a printer. However, the foregoing embodiments are for the purpose of elucidating the present invention and are not to be interpreted as limiting the present invention. The invention can of course be altered and improved without departing from the gist thereof and includes functional equivalents. In particular, the embodiments mentioned below are also included in the scope of invention.

Regarding the Printer

In the above-described embodiment, the printer 4 performs scene classification processing, display of a confirmation screen, and the like. However, it is also possible that the digital still camera 2 performs scene classification processing, display of a confirmation screen, and the like. Moreover, the information processing apparatus that performs the above-described scene classification processing and display of a confirmation screen is not limited to a printer 4 or a digital still camera 2. For example, an information processing apparatus such as a photo storage device for saving a large number of image files may perform the above-described scene classification processing and display of a confirmation screen as well. Naturally, a personal computer or a server located on the Internet may perform the above-described scene classification processing and display of a confirmation screen as well.

Regarding the Image File

The above-described image files are Exif format files. However, the image file format is not limited to this. Moreover, the above-described image files are still image files. However, the image files also may be moving image files. That is to say, as long as the image files contain the image data and the supplemental data, it is possible to perform the scene classification processing etc. as described above.

Regarding the Support Vector Machine

The above-described sub-classifying sections 51 and sub-partial classifying sections 61 employ a classification method using a support vector machine (SVM). However, the method for classifying whether or not the image to be classified belongs to a specific scene is not limited to a method using a support vector machine. For example, it is also possible to employ pattern recognition techniques, for example with a neural network.

Regarding the Method for Extracting Scene Candidates

In the above-described embodiments, if the scene cannot be classified by any of the overall classification processing, partial classification processing, and integrative classification processing, then scenes whose degree of certainty is equal to or greater than a predetermined value are extracted as scene candidates. However, the method for extracting scene candidates is not limited to this.

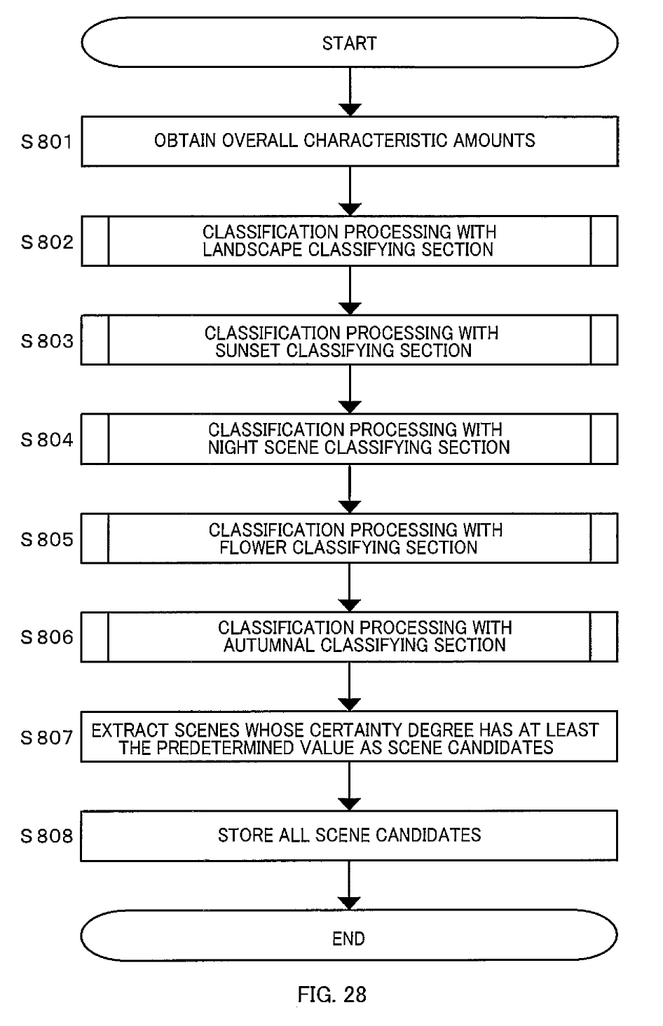

FIG. 28 is an explanatory diagram of a separate process flow. This process can be carried out instead of the above-described scene classification processing.

First, as in the above-described embodiments, the printer controller 20 calculates the overall characteristic amounts, based on the information of the image file (S801). Then, like in the above-described classification processing, the landscape classifying section 51L calculates the value of the discriminant equation and the Precision corresponding to this value as the degree of certainty (S802). It should be noted that the landscape classifying section 51L of the above-described embodiment classifies whether or not the image to be classified belongs to landscape scenes, but here, the landscape classifying section 51L only calculates the degree of certainty based on the discriminant equation. Similarly, also other the sub-classifying sections 51 calculate the degree of certainty (S803 to S806). Then, the printer controller 20 extracts the scenes having a degree of certainty that is equal to or greater than a predetermined value as scene candidates (S807), and stores the scene candidates (and their degree of certainty) (S808).

Also in this manner, it is also possible to classify the scene of an image represented by image data. Then, the scene classified like this is compared with the scene of the supplemental data, and if there is a mismatch, it is also possible to display a confirmation screen.

### Overview

(1) In the above-described embodiments, the printer controller 20 obtains the scene capture type data and the shooting mode data, which are scene information, from the supplemental data appended to the image data. Further, the printer controller 20 obtains the classification result of the face detection processing and the scene classification processing (see FIG. 8).

The scene indicated by the scene capture type data and the shooting mode data may not match the scene of the classification result of the scene classification processing. In this case, a confirmation screen prompting the user to make a confirmation is displayed.

(2) However, if a plurality of image files are subjected to direct printing, and the information for all image files is displayed as in the confirmation screen of the first embodiment (see FIG. 23), then the amount of information about the images that needs to be confirmed by the user becomes large. Accordingly, in the confirmation screen of the second embodiment, only images for which the two scenes (the scene indicated by the supplemental data and the scene indicated by the classification result) do not match are displayed, and images for which the two scenes (the scene indicated by the supplemental data and the scene indicated by the classification result) match are not displayed (see FIGS. 25 and 26).

Thus, for example in the confirmation screen 164 of FIG. 25, the images 164A can be displayed largely. Further, for example with the confirmation screen 165 of FIG. 26, it is possible to display both the scene of the supplemental data as well as the scene of the classification processing result for each of the images 165A. Thus, by not displaying images for which the two scenes (the scene indicated by the supplemental data and the scene indicated by the classification result) match, it is possible to increase the amount of information on the confirmation screen for images with a mismatch between the two scenes (the scene indicated by the supplemental data and the scene indicated by the classification result).

(3) In the above-described embodiments, before the image enhancement processing (which is one example of image processing) or the print processing (which is another example of image processing) is carried out for a first image for which there is a mismatch between the two scenes (the scene indicated by the supplemental data and the scene indicated by the classification result), a second image for which there is no mismatch between the two scenes (the scene indicated by the supplemental data and the scene indicated by the classification result) is subjected to image enhancement processing and print processing (see S704 of FIG. 24, FIG. 25) based on the classification processing result. Thus, it is possible to advance the processing of the second image without waiting for the confirmation of the first image, so that the image enhancement and the print processing can be started earlier than in the comparative example.

(4) In the above-described embodiments, when a confirmation screen is displayed for a first image for which there is a mismatch between the two scenes (the scene indicated by the supplemental data and the scene indicated by the classification result) (see S707 in FIG. 24; FIG. 25), then a second image for which there is no mismatch between the two scenes (the scene indicated by the supplemental data and the scene indicated by the classification result) is subjected to image enhancement processing and print processing based on the classification processing result (see S704). Thus, it is possible to advance the processing of the second image without waiting for the confirmation of the first image, so that the image enhancement and the print processing can be started earlier than in the comparative example.

(5) The above-described printer controller 20 executes jobs in accordance with the degree of priority of the jobs. Moreover, in the above-described embodiments, the job for the first image for which there is a mismatch between the two scenes (the scene indicated by the supplemental data and the scene indicated by the classification result) is created after displaying the confirmation screen (S709). On the other hand, the job for the second image for which there is no mismatch between the two scenes (the scene indicated by the supplemental data and the scene indicated by the classification result) is created before displaying the confirmation screen (S704). Thus, it is possible to create the job for the second image without waiting for the confirmation of the first image, so that the image enhancement and the print processing can be started earlier than in the comparative example.

(6) In the above-described embodiments, the printer controller 20 changes the priority order of the jobs after creating a job in S709 (that is, after creating a job of an image for which there is a mismatch between the two scenes (the scene indicated by the supplemental data and the scene indicated by the classification result). Thus, it is possible to increase the number of images that can be printed in the order of their numbers.

(7) After a job has been created in S709, the above-described printer controller 20 judges whether a plurality of image files to be subjected to direct printing can be printed in the order of their numbers (S710). And if the judgment is “YES” in S710, the printer controller 20 changes the order of the jobs. Thus, the order in which the jobs are executed can be made to be the order of the numbers of the plurality of image files to be subjected to direct printing.

However, in the above-described embodiments, even though the judgment whether all images to be subjected to direct printing can be printed in the order of their numbers is made in S710, there is no limitation to this. For example, if the first image cannot be printed in its order, but the remaining fourth, fifth, and ninth images can be printed in their order, then it is also possible that “YES” is judged in S710, and the order of the jobs is changed. Thus, the number of images that can be printed in the order of their numbers can be increased (for example, the images other than the first image can be printed in their order).

(8) In the above-described embodiments, if the judgment in S710 is “NO”, then the printer 4 does not print the images in the order of the numbers of the image files, so that the printer controller 20 may also display a warning screen to indicate this to the user on the display section 16. Thus, the user can note when the printed images are not ordered in their original order.

(9) The above-described printer 4 (corresponding to an information processing apparatus) includes the printer controller 20 and the display section 16. The printer controller 20 obtains the scene capture type data and the shooting mode data, which are the scene information, from the supplemental data appended to the image data. Further, the printer controller 20 obtains the classification result of the face detection processing and the scene classification processing (see FIG. 8). The scene indicated by the scene capture type data or the shooting mode data is compared with the scene of the classification processing result. Then, the printer controller 20 displays a confirmation screen on the display section 16, if there is an image for which there is a mismatch between the scene of the supplemental data and the scene of the classification processing result (see S707).

Then, the above-described printer controller 20 displays the information for the mismatch images on the confirmation screen, whereas the matching images for which there is no mismatch between the scene indicated by the scene information and the classified scene are not displayed. Thus, the amount of information on the confirmation screen for the images for which there is no mismatch between the two scenes (the scene indicated by the supplemental data and the scene indicated by the classification result) can be increased.

(10) The above-described memory 23 has a program stored therein, which causes the printer 4 to execute the processes shown for example in FIG. 24. This program includes code for obtaining scene information concerning image data from supplemental data that is appended to the image data for image data of a plurality of images, code for classifying the scenes of images represented by the image data based on that image data, code for comparing the scenes indicated by the scene information with the classified scenes, and code for displaying a confirmation screen if there is a mismatch image for which the scene indicated by the scene information does not match the classified scene. Further, this program displays the information concerning the mismatch images on the confirmation screen, but does not display the matching images for which there is no mismatch between the scene indicated by the scene information and the classified scene. Thus, the amount of information on the confirmation screen for the images for which there is a mismatch between the two scenes (the scene indicated by the supplemental data and the scene indicated by the classification result) can be increased.

Although the preferred embodiment of the present invention has been described in detail, it should be understood that various changes, substitutions and alterations can be made therein without departing from spirit and scope of the inventions as defined by the appended claims.

What is claimed is:

1. An information processing method, comprising:
for image data of each of a plurality of images,
obtaining scene information concerning the image data from supplemental data that is appended to the image data,
classifying a scene of an image represented by the image data, based on the image data,
comparing the classified scene with a scene indicated by the scene information; and
if there is a mismatch image for which the classified scene does not match the scene indicated by the scene information, displaying information concerning the mismatch image on a confirmation screen.

2. An information processing method according to claim 1,
wherein information concerning the mismatch image is displayed on the confirmation screen, and a matching image for which there is no mismatch between the classified scene and the scene indicated by the scene information is not displayed on the confirmation screen.

3. An information processing method according to claim 1,
wherein a matching image for which there is no mismatch between the classified scene and the scene indicated by the scene information is subjected to image processing before the mismatch image is subjected to image processing.

4. An information processing method according to claim 1,
wherein a matching image for which there is no mismatch between the classified scene and the scene indicated by the scene information is subjected to image processing while the confirmation screen is displayed.

5. An information processing method according to claim 1,
wherein a print job for a matching image for which there is no mismatch between the classified scene and the scene indicated by the scene information is created before displaying the confirmation screen;
a print job for the mismatch image is created after displaying the confirmation screen; and
the print jobs are executed in accordance with a priority order of the print jobs.

6. An information processing method according to claim 5,
wherein the priority order of the print jobs is changed after creating the print job for the mismatch image.

7. An information processing method according to claim 6,
wherein, after creating the print job for the mismatch image:
if the print jobs can be executed in accordance with a predetermined order for the image data of the plurality of images, the priority order of the print jobs is changed to the predetermined order; and
if the print jobs cannot be executed in accordance with the predetermined order for the image data of the plurality of images, the priority order of the print jobs is not changed.

8. An information processing method according to claim 7,
wherein, after creating the print job for the mismatch image, if the print jobs cannot be executed in accordance with the predetermined order for the image data of the plurality of images, a warning screen is displayed.

9. An information processing apparatus comprising a controller,
wherein the controller, for image data of a plurality of images,
obtains scene information concerning the image data from supplemental data that is appended to the image data,
classifies a scene of an image represented by the image data, based on the image data,
compares the classified scene with a scene indicated by the scene information, and
if there is a mismatch image for which the classified scene does not match the scene indicated by the scene information, displaying information concerning the mismatch image on a confirmation screen.

10. A storage medium storing a program that causes an information processing apparatus to, for image data of a plurality of images,
obtain scene information concerning the image data from supplemental data that is appended to the image data,
classify a scene of an image represented by the image data, based on the image data,
compare the classified scene with a scene indicated by the scene information, and
if there is a mismatch image for which the classified scene does not match the scene indicated by the scene information, display information concerning the mismatch image on a confirmation screen.
